(19) United States
(12) Patent Application Publication
(10) Pub. No.: US 2008/0231768 A1
(43) Pub. Date: Sep. 25, 2008

(54) PHOTOELECTRIC SENSOR, INFORMATION RECORDING METHOD, AND INFORMATION RECORDING SYSTEM

(75) Inventor: MASATO OKABE, TOKYO (JP)

Correspondence Address: MORGAN AND FINNEGAN;345 PARK AVENUE, NEW YORK, NY, 10154, US

(73) Assignee: DAI NIPPON PRINTING CO., LTD.

(21) Appl. No.: 08/428,325

(22) Filed: Apr. 25, 1995

(30) Foreign Application Priority Data
Apr. 27, 1994 (JP) 089489
Apr. 17, 1995 (JP) 091030

(51) Int. Cl. G02F 1/135

(52) U.S. Cl. 349/25

(57) ABSTRACT

The present invention relates to an information recording system comprising an information recording medium and a photoelectric sensor capable of recording light information on the information recording medium in the form of visible information or electrostatic information, and to an information recording method wherein light information is recorded on an information recording medium utilizing an photoelectric sensor.

### BACKGROUND OF THE INVENTION

The present invention relates to an information recording system comprising an information recording medium and a photoelectric sensor capable of recording light information on the information recording medium in the form of visible information or electrostatic information. More particularly, the present invention relates to a photo-electric sensor including a photoconductive layer that enables the ability of an information recording medium to record information to be noticeably amplified as well as an w information recording method and system that uses this photoelectric sensor.

There has so far been an information recording and reproducing method in which a photoelectric sensor having a photoconductive layer provided with an electrode on the front side is opposed, on the optical axis, to an information recording medium having an electric charge retaining layer provided with an electrode on the rear side thereof, and the sensor is exposed to light with voltage being applied between the two electrodes, thereby enabling electrostatic charge corresponding to the incident optical image to be recorded on the electric charge retaining layer, and then the recorded electrostatic information is reproduced by toner development or electric potential reading method, as typically described in JP-A 1-290366 and 1-289975. There is another conventional information recording and reproducing method in which the electric charge retaining layer used in the above-described method is replaced by a thermoplastic resin layer, and after electrostatic charge has been recorded on the surface of the thermoplastic resin layer, heating is carried out to form a frost image on the surface of the thermoplastic resin layer, thereby making the recorded electrostatic charge visible, as typically described in JP-A 3-192288.

Applicants have already filed Japanese Patent Application Nos. 4-173030 and 5-101277 in which there is claimed an information recording and reproducing method wherein the information recording layer used in the above information recording medium is formed of a liquid crystal-polymer composite material layer. As mentioned above, the photoelectric sensor is exposed to light at an applied voltage to align the liquid crystals of the liquid crystal layer by an electric field created by the photoelectric sensor, thereby recording information on the recording medium. The thus recorded information is reproduced in the form of visible information by transmitted or reflected light. With this information recording and reproducing method, it is possible to make the recorded information visible without recourse to a polarizing plate.

In the information recording method using such a photoelectric sensor and an information recording layer comprising a liquid crystal phase, incident information light is directed to the sensor with voltage applied between the electrodes. Thereupon, photocarriers are generated in the photoconductive layer at the portion on which the light is incident. Then, the photocarriers are moved by an electric field created by both electrodes, resulting in the redistribution of the voltage. Thus, the liquid crystals in the liquid crystal phase of the information recording layer are aligned, thereby recording the information according to the pattern of information light. Upon a continued application of voltage even after the exposure of the photoelectric sensor to information light has been finished, the sensor shows a sustained conductivity so that the recording of the information on the information recording layer can be continued. The operating voltage and its range vary with liquid crystals. Thus, when the voltage to be applied and the voltage applying time are to be predetermined, it is preferable to make proper determination of the voltage distribution in the information recording medium so that the voltage distributed to the information recording layer can be set within the operating voltage range of the liquid crystal used. This recording method makes planar analog recording possible, and enables information to be recorded with high resolution. The exposure pattern is retained in the form of a visible image by the alignment of the liquid crystals in the liquid crystal phase.

A camera or laser may be used for recording information. When the camera is used, the information recording medium is used in place of photographic film used with an ordinary camera. In this case, either an optical shutter or an electrical shutter may be used. For color photography, light information is separated through a combined prism and color filter into R, G and B light components in the form of parallel beams, which are in turn recorded on three R, G and B information recording media to form one frame. Alternatively, the R, G and B images may be recorded on three discrete regions of one information recording medium to form one frame.

Reference is here made to, for instance, a photoelectric sensor including a bisazo pigment-containing photoconductive layer on an ITO film formed on a glass substrate. FIG. 1 is a current vs. time graph of this photoelectric sensor when it is exposed to 20-lux green light at an applied voltage of 200 volts. The exposed portion L1 is more increased in conductivity than the unexposed portion L2. FIG. 2 is a simulated voltage vs. time graph for the exposed and unexposed portions of a liquid crystal recording layer of an information recording medium made up of liquid crystals, when the information recording medium is taken as a parallel circuit comprising a capacitor and a resistance. Since the exposed portion is higher in conductivity than the unexposed portion, the voltage applied to the liquid crystal layer is much more increased, so that the liquid crystals at the exposed portion can be aligned to record an image.

Therefore, unless the conductivity difference between the exposed and unexposed portions shown in FIG. 1 reaches a certain value, it is then impossible to record an image of good quality on the liquid crystal recording medium.

When voltage is applied to the photoelectric sensor and liquid crystal recording medium in such a way, there are the optimum values for the voltage applying time and applied voltage. For instance, when the voltage applying time is too long, no image can be recorded on the liquid crystal recording medium, because the liquid crystals at the unexposed portion are aligned, too.

The voltage applying time may be extended by lowering the applied voltage. At too low an applied voltage, however, no image can again be recorded because the voltage of the liquid crystal recording medium at the unexposed portion does not reach the threshold voltage.

As described above, it is required that when information is recorded, the application of voltage be finished within a prescribed time; that is, no effective recording of information is achieved even when the application of voltage is continued after an elapse of that time.

In most cases, the voltage applying time, albeit varying depending on the characteristics of an photoelectric sensor or an information recording medium, is within 200 milliseconds, often within about 30 milliseconds to about 50 milliseconds. The voltage applying time is predominantly determined by the current value of the unexposed portion, and is hardly dependent on exposure intensity and exposure time.

With silver halide photography that enables images to be recorded over a wide range of light intensity, it is possible to record an image of good quality by extending exposure time even when an image of low exposure intensity is recorded. Unless conditions are very severe, images of similar quality can be obtained either when film is exposed to weak light for a long time or when film is exposed to intense light for a short time; that is, the reciprocity law can apply.

FIG. 3 is a current vs. time graph when a photoelectric sensor is exposed to 6-lux light for 200 milliseconds at an applied voltage of 200 volts, and FIGS. 4 and 5 show current value differences between the exposed and unexposed portions when the photoelectric sensor is exposed to 6-lux light and 20-lux light, respectively.

When the photoelectric sensor is exposed to light at an intensity of 6 luxes, a photo-induced current corresponding to the difference between the unexposed and exposed portions can be obtained by continuing exposure for an extended time at much the same level as can be achieved by exposure at 20 luxes, as can be seen from FIG. 4.

However, such a photoelectric sensor cannot be used to record information by a prior art recording method wherein the application of voltage is started at the same time as exposure. The reason is that the voltage applying time (the time taken for the unexposed portion to reach the threshold voltage) is about 30 milliseconds to about 50 milliseconds. Within such a short time, it is impossible to record an image of good quality, because the current value obtained by exposure at 6 luxes is smaller than that by exposure to 20-lux light.

With such a conventional method, no information can be recorded at a low exposure intensity. This is true of even when voltage is applied to the photoelectric sensor until the voltage of the unexposed portion reaches the threshold voltage.

The latitude of the recorded image often becomes narrow, although depending on voltage applying conditions. In this case, no sufficient expression of the subject is achieved due to some problems inclusive of washed-out highlights and flat shadow areas.

In silver halide photography that is the most generally used image recording method, the reciprocity law can apply over a wide range. For instance, if the diaphragm is opened (or exposure intensity is enhanced) and the shutter is clicked at high speed, it is then possible to bring only a specific portion of the subject into focus and thereby shade off other portion of the subject. On the contrary, if the shutter is clicked at low speed upon the diaphragm stopped down, it is then possible to bring a wide range including the subject into focus. Thus, the reciprocity law can be satisfied by controlling shutter speed and f-number so that the same exposure quantity can be achieved. Furthermore, if shutter speed is changed depending on exposure intensity, the same film can then be used to take a shot of an outdoor scene on a fine day or a night scene.

When an image is recorded using the system of the present invention comprising a photoelectric sensor and a liquid crystal medium, however, the reciprocity law needed for photography fails, because no image can be recorded on the liquid crystal medium even when the exposure of the sensor to image light is continued after an elapse of the voltage applying time; that is, the sensor cannot be exposed to light over an extended period of time. Nor can the reciprocity law apply even in a region where exposure time is extremely short. Thus, such reciprocity law failure offers problems when photographs of various subjects are taken under diverse conditions.

### SUMMARY OF THE INVENTION

One object of the present invention is to enable information to be recorded on an information recording medium by an extended exposure when exposure intensity is low.

Another object of the present invention is to enable images to be recorded over a wide latitude range.

Still another object of the present invention is to enable various pieces of image information in a region where the reciprocity law fails to be recorded under diverse conditions by compensating for reciprocity law failures.

Throughout the disclosure, the “image information” is understood to mean image-bearing information. Likewise, the “information or image light” is understood to refer to information- or image-bearing light.

According to one aspect of the present invention, there is provided a photoelectric sensor including a photoconductive layer on an electrode and used to record information on an information recording medium, characterized in that when voltage is applied to said sensor after said sensor has been exposed to light with no voltage applied thereto or voltage of opposite polarity applied thereto, a photo-induced current is generated depending on exposure quantity so that the information can be recorded on said information recording medium.

According to another aspect of the present invention, there is provided a photoelectric sensor including a photo-conductive layer on an electrode and used to record information on an information recording medium, characterized in that said sensor is exposed to information light with voltage applied thereto, whereby the exposed portion is made higher in conductivity than the unexposed portion and the exposed portion is kept still higher in conductivity than the unexposed portion even after the exposure of said sensor to information light has been finished, and while said sensor remains exposed to information light or after the exposure of said sensor to information light has been finished, the application of voltage thereto is interrupted or voltage of opposite polarity is applied thereto, and then the original voltage is again applied thereto, whereby the resulting conductivity is made equal to that obtained by the continued application of voltage.

Preferably, the present invention is further characterized in that when an electric field of 10⁵ to 10⁶ V/m is applied to the photoelectric sensor, a current passing through the unexposed portion has a current density of 10⁻⁴ to 10⁻⁷ A/cm².

According to a further aspect of the present invention, there is provided an image recording method wherein light information is recorded on an information recording medium by exposure to light information, characterized by use of the above-defined photoelectric sensor and an information recording medium having an information recording layer formed on an electrode,

the electrode of at least one of said photoelectric sensor and said information recording medium being a transparent electrode, and

said photoelectric sensor being opposed to said information recording medium on the optical axis with a gap located therebetween, or said photoelectric sensor and said information recording medium being stacked on each other with or without a dielectric interlayer located therebetween,

so that after said sensor has been exposed to light information or while said sensor is being exposed to light information, the application of voltage between both said electrodes is started.

Preferably, the present invention is further characterized in that the above information recording medium is a liquid crystal recording medium including on an electrode a liquid crystal-polymer composite material layer comprising liquid crystals and resin.

Preferably, the present invention is further characterized in that after an elapse of a certain time upon the exposure of the photoelectric sensor to light information finished, the application of voltage to both electrodes is started. thereby making the latitude of the recorded image wide.

Preferably, the present invention is further characterized in that the period of time from the finish of the exposure of the photoelectric sensor to light information to the start of the application of voltage to both electrodes is 0 to 500 milliseconds.

According to a still further aspect of the present invention, there is an image recording method wherein light information is recorded on an information recording medium by exposure to information light, characterized by use of the above-defined photoelectric sensor and an information recording medium including an information recording layer formed on an electrode,

the electrode of at least one of said photoelectric sensor and said information recording medium being a transparent electrode, and

said photoelectric sensor being opposed to said information recording medium on the optical axis with a gap located therebetween, or said photoelectric sensor and said information recording medium being stacked on each other with or without a dielectric interlayer located therebetween,

so that said sensor is exposed to light information, and while said sensor is being exposed to light information or after said sensor has been exposed to light information, the period of time wherein no voltage is applied to both said electrodes or the period of time wherein voltage of opposite polarity is applied to both said electrodes is provided.

According to a still further aspect of the present invention, there is provided an image recording method wherein light information is recorded on an information recording medium by exposure to light information, wherein the above-defined photoelectric sensor and an information recording medium having an information recording layer formed on an electrode are used,

the electrode of at least one of said photoelectric sensor and said information recording medium being a transparent electrode, and

said photoelectric sensor being opposed to said information recording medium on the optical axis with a gap located therebetween, or said photoelectric sensor and said information recording medium being stacked on each other with or without a dielectric interlayer located therebetween,

so that said sensor is exposed to light information and voltage is applied between both electrodes of said sensor and said recording medium to record information thereon, characterized in that:

the exposure of said sensor to image light and the application of voltage to both said electrodes are properly achieved in response to shutter speed, so that the reciprocity law can be satisfied over a wide range.

Preferably, the present invention is further characterized in that f-number or exposure time is corrected on the basis of the predetermined relation between the shutter speed and the recording properties, so that the reciprocity law can be satisfied over a wide range.

Preferably, the present invention is further characterized in that a reciprocity law failure is compensated for by starting the exposure of the above-defined photoelectric sensor to image light prior to starting the application of voltage to both electrodes.

Preferably, the present invention is further characterized in that the period of time wherein no voltage is applied to both electrodes or the period of time wherein voltage of opposite polarity is applied to both electrodes is provided while the above-defined photoelectric sensor is being exposed to image light or after the exposure of the photoelectric sensor to image light has been finished, thereby compensating for a reciprocity law failure.

Preferably, the present invention is further characterized in that the application of voltage to both electrodes is started after an elapse of a certain time upon the exposure of the above-defined photoelectric sensor to image light finished.

Preferably, the present invention is further characterized in that the applied voltage and/or the voltage applying time are controlled, thereby compensating for a reciprocity law failure.

According to a still further aspect of the present invention, there is provided an image recording system wherein light information is recorded on an information recording medium by exposure to information light, characterized by comprising a photoelectric sensor including an electrode and an information recording medium having an information recording layer formed on an electrode,

the electrode of at least one of said photoelectric sensor and said information recording medium being a transparent electrode, and

said photoelectric sensor being opposed to said information recording medium on the optical axis with a gap located therebetween, or said photoelectric sensor and said information recording medium being stacked on each other with or without a dielectric interlayer located therebetween, and

a mechanism for starting the application of voltage between both said electrodes after said sensor has been exposed to light information or while said sensor is being exposed to light information.

According to a still further aspect of the present invention, there is provided an information recording system constructed from a one-piece type medium comprising a photoelectric sensor having a photoconductive layer stacked on a transparent electrode, an information recording medium having an information recording layer stacked on an electrode and an upper electrode, said photoelectric sensor being opposed to said information recording medium on the optical axis with a gap located therebetween, or said photoelectric sensor being stacked on said information recording medium with or without a dielectric interlayer located therebetween, wherein said photoelectric sensor is exposed to image light and voltage is applied between both said electrodes to record image or other information on said information recording medium in response to exposure quantity, characterized by further including means for measuring exposure intensity to calculate exposure time and/or input means for exposure time, and having a function of controlling a shutter and a power source under proper conditions in response to the exposure time, thereby allowing the reciprocity law to be satisfied over a wide range of exposure time.

### BRIEF DESCRIPTION OF THE DRAWINGS

FIG. 1 is a current vs. time graph showing the results, as measured, of a current passing through a photoelectric sensor exposed to light at the same time as voltage is applied thereto,

FIG. 2 is a simulated voltage vs. time graph for the exposed and unexposed regions of a liquid crystal recording layer of an information recording medium made up of liquid crystals and resin for supporting them, when the information recording medium is takes as being a parallel circuit comprising a capacitor and a resistance,

FIG. 3 is a current vs. time graph showing the results of the current value measured when a photoelectric sensor is exposed to 6-lux light for 200 milliseconds at an applied voltage 200 volts,

FIG. 4 is a current vs. time graph showing a current value difference between the exposed and unexposed portions of a photoelectric sensor when it is exposed to 6-lux light,

FIG. 5 is a current vs. time graph showing a current value difference between the exposed and unexposed portions of a photoelectric sensor when it is exposed to 20-lux light,

FIG. 6 is a sectional view for illustrating a photoelectric sensor,

FIG. 7 is a sectional view illustrating an information recording system used with the method of the present invention,

FIG. 8 is a view illustrating an information recording method for recording information on the information recording system of the present invention,

FIG. 9 is graphs illustrating one example of the change in the voltage applied to a liquid crystal recording layer and a photoelectric sensor when voltage is repeatedly applied thereto,

FIG. 10 is a view illustrating a method of recording image information by multiple exposure,

FIG. 11 is a view illustrating how to measure the characteristics of the photoelectric sensor of the present invention,

FIG. 12 is a graph illustrating the electrical properties of a photoelectric sensor,

FIG. 13 is a graph showing a photo-induced current represented by a difference between light and dark currents,

FIG. 14 is a graph showing the light and dark currents measured when there is a time lag between the voltage application and exposure start points,

FIG. 15 is a graph showing the results of the photo-induced currents measured in different voltage applying and exposure modes,

FIG. 16 is a graph showing one example of the results of the photo-induced currents measured when the photoelectric sensor is exposed to light at a constant applied voltage and at a rectangular wave form of applied voltage,

FIG. 17 is a graph showing another example of the results of the photo-induced currents measured when the photoelectric sensor is exposed to light at a constant applied voltage and at a rectangular wave form of applied voltage,

FIG. 18 is a view showing an equivalent circuit of a liquid crystal recording medium,

FIG. 19 is a view showing the ability of a photo-electric sensor to record information, FIG. 20 is a graph illustrating one example of the results of the photo-induced current measured in the case of the application of voltage after the finish of exposure,

FIG. 21 is a graph illustrating another example of the results of the photo-induced current measured in the case of the application of voltage after the finish of exposure,

FIG. 22 is a graph illustrating still another example of the results of the photo-induced current measured in the case of the application of voltage after the finish of exposure,

FIG. 23 is a graph illustrating the results of a voltage difference between exposed and unexposed portions, as obtained by simulation,

FIG. 24 is a graph illustrating the results of the photo-induced current measured when the photoelectric sensor is exposed to light at a varying illuminance, with voltage applied to the electrodes,

FIG. 25 is a view illustrating one construction of the image recording system for changing latitude,

FIG. 26 is a view illustrating an image recording method wherein the period of time from the start of exposure to image light to the voltage application start is varied,

FIG. 27 is a graph illustrating the results measured when an image is recorded by the method of FIG. 26,

FIG. 28 is a graph illustrating the results, as measured, of the photo-induced current obtained at an extended exposure time,

FIG. 29 is a view showing a recording method wherein the photoelectric sensor is exposed to image light while voltage is being applied to the electrodes,

FIG. 30 is a view illustrating a reciprocity law failure,

FIG. 31 is a view illustrating a voltage applying and exposure method wherein the exposure of the photoelectric sensor to light is still continued while voltage is being applied: to the electrodes or after the application of voltage to the electrodes has been finished,

FIG. 32 is a view illustrating a voltage applying and exposure method wherein the exposure of the photoelectric sensor to light is started prior to the application of voltage to the electrodes,

FIG. 33 is a plot showing the results, as measured, of the signals read when the photoelectric sensor is exposed to light at the same time as, and prior to, the application of voltage to the electrodes,

FIG. 34 is a view showing a recording method wherein the photoelectric sensor is exposed to image light before the application of voltage to the electrodes is started,

FIG. 35 is a plot showing the results, as measured, of the signals read when the photoelectric sensor is exposed to image light at the same time as the application of voltage to the electrodes and before the application of voltage of the electrodes is started,

FIG. 36 is a view illustrating a voltage applying and exposure method wherein the period of time from the exposure of the photoelectric sensor to image light to the start of the application of voltage is varied,

FIG. 37 is a plot showing the results, as measured, of the signals read at a high applied voltage,

FIG. 38 is a plot showing the results, as standardized, of transmittance between the unexposed and exposed portions in FIG. 37,

FIG. 39 is a view illustrating a method for synchro-flash photography,

FIG. 40 is a view illustrating a recording method wherein voltage is applied plural times to the electrodes while the photoelectric sensor is being exposed to light at an extended time,

FIG. 41 is a view showing one construction of the image recording system of the present invention,

FIG. 42 is a view showing a camera used according to the recording method of the present invention,

FIG. 43 is a view showing one example of a medium holder,

FIG. 44 is a view showing one example of the sequence of images,

FIG. 45 is a view showing another example of the sequence of images, and

FIG. 46 is a view showing still another example of the sequence of images.

### DESCRIPTION OF THE PREFERRED EMBODIMENT

The photoelectric sensor of the present invention includes a photoconductive layer stacked on an electrode. The photoconductive layer may then have a single-layer structure or a multilayer structure including a carrier generation layer and a carrier transport layer, which are stacked one upon another. The photoconductive layer generally functions such that when it is irradiated with light, photocarriers (electrons and holes) are generated in the irradiated portion, so that these carriers are movable across the width of the layer. By suitable combination of the photoconductive layer and electrode (as will be described later), semi-conductivity is imparted to the photoelectric sensor of the present invention. This enables an electric field or electric charge, which is given to an information recording medium upon the photoelectric sensor irradiated with light, to be amplified with time while it is irradiated with light. In addition, even after the irradiation of the photoelectric sensor with light has been finished, the sensor sustains the increased conductivity by a continued application of voltage, so that a continued application of the electric field or charge to an associated information recording medium can be achieved.

The photoelectric sensor of the present invention has sustained conductivity and an amplifying action. However, photosensitive materials so far known to have sustained conductivity have electrical insulating properties in themselves; that is, they can have sustained conductivity in the process of imparting conductivity to them as by irradiating them with light. On the other hand, the photoelectric sensor of the present invention has semiconductive properties in itself. This is an essential requirement for achieving the action of the present invention; in other words, the action of the present invention would not be achieved with electrical insulating materials.

FIG. 6 is a sectional view for illustrating the photo-electric sensor.

The photoelectric sensor 10 includes a photoconductive layer 13 on an electrode 12 formed on a substrate 11. The photoconductive layer 13 is made up of a carrier generation layer 14 and a carrier transport layer 15. Upon irradiated with light, the photoconductive layer generates photo-carriers such as electrons and holes in the irradiated portion, which are then movable across the width of the layer. Especially in the presence of an electric field, such effect becomes much more pronounced.

The carrier generation layer 14 comprises a binder resin and a carrier generation substance. Examples of the carrier generation substance usable in the present invention are cationic dyes, e.g., pyrylium dyes, thiapyrylium dyes, azulenium dyes, cyanine dyes, azulenium salt dyes, etc., squalium salt dyes, phthalocyanine pigments, perylene pigments, polycyclic quinone pigments, e.g., pyranthrone pigments, etc., indigo pigments, quinacridone pigments, pyrrole pigments, and azo pigments. Combinations of two or more of these dyes and pigments may be used in a single layer. Alternatively, two carrier generation layers may be provided, each layer containing a single carrier generation substance.

The carrier generation layer may further contain an electron accepting substance, examples of which are 2,4,7-trinitrofluorenone, tetrafluoro-P-benzoquinone, tetracyanoquinodimethane, triphenylmethane, maleic anhydride, and hexacyanobutadiene, all mentioned for the purpose of illustration alone.

For the binder resin, for instance, mention may be made of polyvinyl chloride resin, polyvinyl acetate resin, acrylic resin, polyester resin, polyvinyl formal resin, polyvinyl bytral resin, polystyrene resin, polycarbonate resin, polybutyl methacrylate resin, polyvinylidene chloride resin, ethyl cellulose resin, silicone resin, epoxy resin, phenol resin, melamine resin, ultraviolet curing resin, thermosetting resin, vinyl chloride-vinyl acetate copolymer resin, vinyl chloride-acrylic copolymer resin, vinyl chloride-ethylene copolymer resin, acrylic-styrene copolymer resin, styrene-butadiene copolymer resin, and ethylene-vinyl acetate copolymer resin.

The binder resin herein used should preferably have an average molecular weight of 1,000 to 100,000, because a binder resin having a higher molecular weight is poor in the ability to be coated.

It is desired that the binder resin be mixed with the carrier generation substance in an amount of 0 to 10 parts by weight, preferably 0.3 to 1 part by weight per part by weight of the carrier generation substance. The electron accepting substance may be used at a molar ratio of 0.0001 to 10 moles per mole of the carrier generation substance. The carrier generation layer should preferably have a thickness of 0.01 to 1 μm, particularly 0.1 to 0.3 μm as measured upon drying.

The carrier transport layer 15 is made up of a carrier transport substance and a binder. The carrier transport substance is a substance well capable of transporting carriers generated in the carrier generation layer. For instance, mention may be made of oxadiazole, oxazole, triazole, thiazole, triphenylmethane, styryl, pyrazoline, hydrazone, aromatic amine, carbazole, polyvinyl carbazole, stilbene, enamine, azine, butadiene, and polycyclic aromatic compounds. In particular, the carrier transport substance must be well capable of transporting holes.

The preferable carrier transport substances are the butadiene and stilbene compounds. It is more preferable to use carrier transport materials disclosed in JP-A 62-287257, 58-182640, JP-A 48-43942, JP-B 34-5466, JP-A 58-198043, JP-A 57-101844, JP-A 59-195660, JP-A 60-69657, JP-A 64-65555, JP-A 1-164952, JP-A 64-57263, JP-A 64-68761, JP-A 1-230055, JP-A 1-142654, JP-A 1-142655, JP-A 1-155358, JP-A 1-155357, JP-A 1-161245, and JP-A 1-142643.

Referring to how to combine the carrier generation substance with the carrier transport substance, for instance, it is preferable to combine the fluorenoneazo pigment (the carrier generation substance) with the stilbene or triphenylamine compound (the carrier transport substance), or the bisazo pigment (the carrier generation substance) with the butadiene or hydrazone compound (the carrier transport substance).

When electrons are transported as the carriers in place of holes, the electron transport substance disclosed in JP-A 5-4721 may be used as the electron transport substance. For the binder resin, the same resins as mentioned in connection with the above carrier generation layer may be used. However, it is preferable to use polyvinyl chloride resin, polyvinyl acetate resin, acrylic resin, polyester resin, polyvinyl formal resin, polyvinyl bytral resin, polystyrene resin, polycarbonate resin, polybutyl methacrylate resin, polyvinylidene chloride resin, ethyl cellulose resin, silicone resin, epoxy resin, phenol resin, melamine resin, vinyl chloride-vinyl acetate copolymer resin, vinyl chloride-acrylic copolymer resin, vinyl chloride-ethylene copolymer resin, acrylic-styrene copolymer resin, styrene-butadiene copolymer resin, polyvinyl acetal resin such as ethylene-vinyl acetate copolymer resin, and styrene resin. However, when the carrier transport substance also serves as a binder resin, it is unnecessary to use the binder resin. The binder resin used should preferably have an average molecular weight of 1,000 to 100,000, because a binder resin having a higher molecular weight is poor in the ability to be coated.

It is desired that the binder resin be used in an amount of 0.05 to 1 part by weight per part by weight of the carrier transport substance. The carrier transport layer has preferably a thickness of 1 to 50 μm, particularly 5 to 30 μm as measured upon drying.

As already mentioned in connection with the carrier generation layer, the carrier transport layer may further contain an electron accepting substance at a molar ratio of 0.0001 to 10 moles per mole of the carrier transport substance. The carrier transport layer having a thickness of 1 to 50 μm, as measured upon drying, may be formed by dissolving or dispersing the carrier transport substance, binder resin and electron accepting substance in the same solvent as mentioned in connection with the carrier generation layer, and coating the solution or dispersion on the carrier generation layer by the same coating technique, followed by drying.

In particular, the photoelectric sensor of the present invention can have an increased sensitivity by the interaction between the carrier generation and transport layers. To improve the efficiency of generating carriers, it is effective to reduce the proportion of the binder resin in the carrier transport layer. However, the reduction in the amount of the binder resin renders it difficult to make the carrier transport layer smooth and gives rise to a change in the efficiency of generating photocarriers on the interface of the carrier generation and transport layers; that is, unless the interface is smooth, no photoelectric sensor of high performance can be achieved.

According to the present invention, it has been found that the sensitivity of a photoelectric sensor can be improved by mixing the carrier transport substance contained in the carrier transport layer with the carrier generation layer. The amount of the carrier transport substance mixed with the carrier generation layer is preferably 0.01 to 10 moles, more preferably 0.1 to 1 mole per mole of the carrier generation substance. At less than 0.01 mole the carrier transport substance has no effect upon added, whereas at higher than 10 moles there is a reduced dark current which is unsuitable for the information recording method according to the present invention.

It is here to be noted that the carrier transport substance mixed with the carrier generation layer may be identical with, or different from, the carrier transport substance used for the carrier transport layer stacked on the carrier generation layer.

The electrode 12 must be transparent if the information recording medium to be described later is opaque. When the information recording medium is transparent, however, the electrode may be either transparent or opaque. The electrode may be formed of materials that ensure a stable surface resistivity of 50 to 104 Ω/cm², for instance, a thin conductive film of metals such as zinc, titanium, copper, iron and tin, a conductive film of inorganic metal oxides such as tin oxide, indium oxide, zinc oxide, titanium oxide, tungsten oxide and vanadium oxide, a conductive film of organic materials such as quaternary ammonium salts, and so on. These materials may be used alone or in composite forms of two or more. Particular preference is, however, given to oxide semiconductors, and indium-tin oxide (ITO).

The electrode 12 may be formed by suitable techniques such as evaporation, sputtering, CVD, coating, plating, dipping, and electrolytic polymerization. The film thickness of the electrode, which must be varied depending on the electrical characteristics of the electrode-forming material and the voltage applied for recording information, may be about 10 to 300 nm for an ITO film, for instance. The electrode may be formed either on the whole area between the substrate and the information recording layer or in conformity with the pattern according to which the photo-conductive layer is formed.

The substrate 11 must be transparent if the information recording medium to be described later is opaque. When the information recording medium is transparent, however, the substrate may be either transparent or opaque. The substrate may have various forms such as card, film, tape or disk forms, and supports the photoelectric sensor with a certain strength. If the photoelectric sensor can be supported by itself, it is unnecessary to use the substrate. Various materials having varying thicknesses may be used, provided that they have a certain strength enough to support the photoelectric sensor. For instance, use may be made of flexible materials such as flexible plastic films, or rigid materials such as glass sheets, plastic sheets such as polyester and polycarbonate sheets, and cards.

It is here to be noted that if the electrode 12 is transparent, a layer having an antireflection effect may optionally be stacked on the surface of the substrate that is opposite to the surface thereof on which the electrode 12 is formed. Alternatively, the transparent substrate may be regulated in terms of film thickness, so that the anti-reflection effect can be achieved. Such an antireflection layer may be used in combination with thickness regulation.

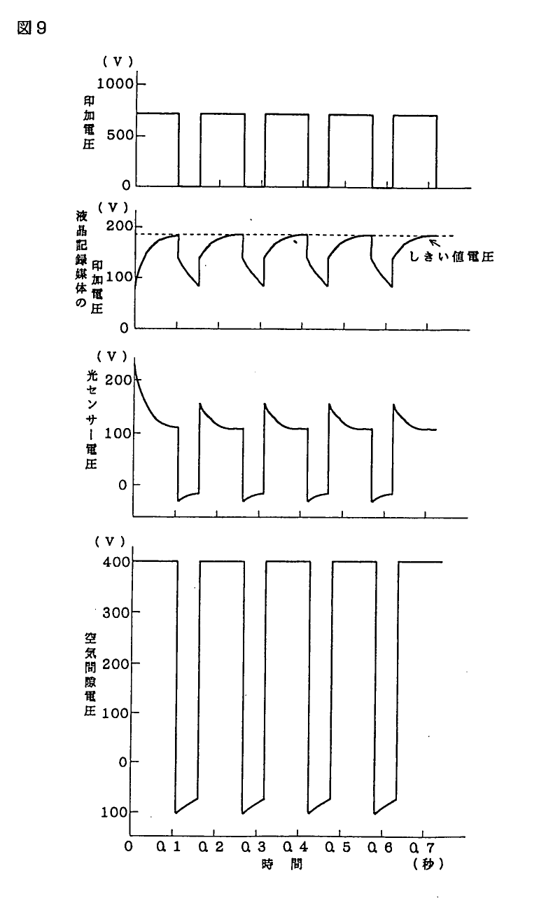

The information recording method of the present invention will now be explained. FIG. 7 is a sectional view for illustrating the information recording system used with the method of the present invention. As illustrated, the photoelectric sensor 10 is stacked on an information recording medium 20 with a spacer 16 interposed between them.

Reference will first be made to the information recording medium 20. The information recording medium according to the present invention includes an information recording layer made up of a liquid crystal-polymer composite material.

The liquid crystal-polymer composite material comprises a resin phase and a liquid crystal phase, and is of a structure having resin particles dispersed in the liquid crystal phase. The liquid crystal material may be smectic, chloesteric or nematic liquid crystals, or their mixture. In view of memory effect, it is preferable to use smectic liquid crystals because they remain so well aligned that information can be permanently carried.

For the smectic liquid crystals, for instance, mention is made of liquid crystal materials showing a smectic A phase, e.g., cyanobiphenyl, cyanoterphenyl, phenylester and fluorine liquid crystal materials, all having a substance of liquid crystallinity with a long terminal carbon chain, liquid crystal materials showing a smectic C phase and used as ferroelectric liquid crystals, or liquid crystal materials showing smectic H, G, E, and F phases.

Nematic liquid crystals may also be used, and may be mixed with smectic or cholesteric liquid crystals so as to achieve an enhanced memory effect. For instance, use may be made of known nematic liquid crystals such as Schiff's base, azoxy, azo, phenyl benzoate, phenylcyclohexlic acid ester, biphenyl, terphenyl, phenylcyclohexane, phenylpyridine, phenyloxazine, polycyclic ethane, phenylcyclohexene, cyclohexylpyrimidine, phenyl, and tolane liquid crystals. Microcapsules of a mixture of the liquid crystal material with polyvinyl alcohol or the like, too, may be used. In view of contrast, it is preferable to select from liquid crystal materials one having large anisotropy of refractive index.

By way of example but preferably, the resin particle-forming material is an ultraviolet curing resin which is compatible with the liquid crystal material when it is in a monomer or oligomer state, or with a solvent common to the liquid crystal material when it is in a monomer or oligomer state. For such ultraviolet curing resins, for instance, mention may be made of acrylic or methacrylic esters. For such resins in a monomer or oligomer state, particular mention is made of polyfunctional monomers or polyfunctional urethanes such as dipentaerythritol hexaacrylate, trimethylolpropane triacrylate, polyethylene glycol diacrylate, polypropylene glycol diacrylate, isocyanuric acid (ethylene oxide modified) triacrylate, dipentaerythritol pentaacrylate, dipentaerythritol tetraacrylate, neopentyl glycol diacrylate and hexanediol diacrylate, and monofunctional monomers or oligomers such as nonylphenol modified acrylate, N-vinyl-2-pyrrolidone and 2-hydroxy-3-phenoxypropyl acrylate.

Any desired solvent may be used, provided that it can be commonly used with the materials used herein. For instance, hydrocarbon solvents represented by xylene, halogenated hydrocarbon solvents represented by chloroform, alcohol derivative solvents represented by methyl cellosolve, and ether solvents represented by dioxane may be used.

Examples of photo-curing agents usable to cure the ultraviolet curing resin are 2-hydroxy-2-methyl-1-phenylpropane-1-one (“Darocure 1173” manufactured by Merck & Co., Inc.), 1-hydroxycyclohexyl phenyl ketone (“Irgacure 184” manufactured by Ciba-Geigy, Ltd.), 1-(4-isopropylphenyl)-2-hydroxy-2-methylpropane-1-one (“Darocure 1116” manufactured by Merck & Co., Inc.), benzyl dimethyl ketal (“Irgacure 651” manufactured by Ciba-Geigy, Ltd.), 2-methyl-1-[4-(methylthio)phenyl]-2-morpholinopropanone-1 (“Irgacure 907” manufactured by Ciba-Geigy, Ltd.), a mixture of 2,4-diethylthioxanthone “Kayacure DETX” manufactured by Nippon Kayaku Co., Ltd.) and p-dimethylaminoethyl benzoate (“Kayacure EPA” manufactured by Nippon Kayaku Co., Ltd.), and a mixture of isopropylthio-xanthone (“Qauntacure-ITX” manufactured by Wordblekinsop Co., Ltd.) and p-dimethylaminoethyl benzoate. However, 2-hydroxy-2-methyl-1-phenylpropane-1-one, which is liquid, is particularly preferable in view of compatibility with the liquid crystal material and polymer-forming monomer or oligomer.

It is preferable to use the liquid crystal and resin materials at such a ratio that the liquid crystal content is 10% to 90% by weight, more particularly 40% to 80% by weight. At less than 10% by weight, there is a lowering of light transmittance even when the liquid crystals of the liquid crystal phase are aligned by recording information, whereas at higher than 90% by weight, the liquid crystals bleed, so making the recorded image uneven. By allowing the information recording phase to contain a large amount of liquid crystals, the contrast ratio can be improved, and the operating voltage can be lowered as well.

The information recording layer may be formed by dissolving or dispersing the resin-forming material, liquid crystal material, photo-curing agent and other components in a solvent to prepare a mixed solution, coating the solution on an electrode by suitable coating techniques using a blade, roll or spin coater, and curing the resin-forming material by light or heat. If required, a leveling agent may be added to the coating solution to improve its ability to be coated and the surface properties of the resulting film.

To form the information recording layer, it is required to heat the mixed solution of the resin-forming material and liquid crystal material at a temperature at which the mixed solution maintains its isotropic phase, and to completely dissolve the liquid crystal and ultraviolet-curing resin-forming material in each other, thereby obtaining an information recording layer in which the resin and liquid crystal phases are uniformly dispersed in each other. If the ultraviolet curing of the resin occurs at a temperature lower than that at which the liquid crystal shows an isotropic phase, there is then a problem that the liquid crystal phase separate largely from the resin material phase. That is, the liquid crystal domain grows too much to allow the skin layer to be completely formed on the surface of the information recording layer. This in turn causes the liquid crystal to bleed or the ultraviolet curing resin to be matted, so making it difficult for the liquid crystal recording layer to accept information accurately. In the worst case, the ultraviolet curing resin fails to retain the liquid crystal, and thereby fails to form any information recording layer. On the other hand, if heating is needed for maintaining the isotropic phase when the solvent is evaporated, the wettability of the mixed solution with respect to the electrode in particular lowers, so failing to make the information recording layer uniform.

A fluorine type of surface active agent is preferably added to the mixed solution for the purpose of maintaining its wettability with respect to the electrode and forming a skin film on the surface of the resin. Examples of the surface active agent used herein are Fluorad FC-430 and FC-431 (manufactured by Sumitomo 3M K.K.), N-(n-propyl)-N-(β-acryloxyethyl)-perfluorooctylsulfonic acid amide (EF-125M manufactured by Mitsubishi Material Co., Ltd.), N-(n-propyl)-N-(β-methacryloxyethyl)-perfluorosulfonic acid amide (EF-135M manufactured by Mitsubishi Material Co., Ltd.), perfluoro-octanesulfonic acid (EF-101 manufactured by Mitsubishi Material Co., Ltd.), perfluorocaprylic acid (EF-201 manufactured by Mitsubishi Material Co., Ltd.), and N-(n-propyl)-N-perfluorooctanesulfonic acid amide ethanol (EF-121 manufactured by Mitsubishi Material Co., Ltd.), as well as EF-102, EF-103, EF-104, EF-105, EF-112, EF-121, EF-122A, EF-122B, EF-122C, EF-122A3, EF-123A, EF-123B, EF-132, EF-301, EF-303, EF-305, EF-306A, EF-501, EF-700, EF-201, EF-204, EF-351, EF-352, EF-801, EF-802, EF-125DS, EF-1200, EF-L102, EF-L155, EF-L174 and EF-L215, all manufactured by Mitsubishi Material Co., Ltd. Additional mention is made of 3-(2-per-fluorohexyl)ethoxy-1,2-dihydroxypropane (ME-100 manufactured by Mitsubishi Material Co., Ltd.), N-n-propyl-N-2,3-di-hydroxypropylperfluorooctylsulfonamide (MF-110 manufactured by Mitsubishi Material Co., Ltd.), 3-(2-perfluorohexyl)ethoxy-1,2-epoxypropane (MF-120 manufactured by Mitsubishi Material Co., Ltd.), N-n-propyl-N-2,3-epoxypropylperfluoro-octylsulfonamide (MF-130 manufactured by Mitsubishi Material Co., Ltd.), perfluorohexylethylene (MF-140 manufactured by Mitsubishi Material Co., Ltd.), N-[3-trimethoxysilyl)propyl]perfluoroheptylcarboxylic acid amide (MF-150 manufactured by Mitsubishi Material Co., Ltd.), N-(3-trimethoxysilyl)propyl)perfluoroheptylsulfonamide (MF-160 manufactured by Mitsubishi Material Co., Ltd.), etc. The fluorine type of surface active agent is used in an amount of 0.1% by weight to 20% by weight with respect to the total amount of the liquid crystal and resin-forming materials.

The coating solution used to form the information recording layer has preferably a solute content of 10% by weight to 60% by weight. By properly determining curing conditions, i.e., the type and concentration of resin, the layer coating temperature and the ultraviolet curing condition, it is possible to form a good-enough skin layer consisting only of a resin layer free from any liquid crystal phase as an outer surface layer. It is thus not only possible to increase the proportion of the liquid crystal material used in the information recording layer but also possible to prevent the bleeding of the liquid crystals.

Although the ultraviolet curing resin materials have been described as resin materials, it is also possible to use thermosetting resin materials which are compatible with a solvent common to the liquid crystal material, for instance, acrylic resin, methacrylic resin, polyester resin, polystyrene resin, copolymers composed mainly of these resins, epoxy resin, silicone resin, etc.

The thickness of the information recording layer, because of having an influence on definition, is preferably in the range of 0.1 μm to 10 μm, especially 3 μm to 8 μm as measured upon dried. Within this thickness range, the information recording layer can be operated at a low voltage yet with high definition. At too small a thickness the contrast of the information recording portion becomes low, whereas at too large a thickness the operating voltage becomes high.

When the information recording layer can be supported by itself, the substrate can be omitted; that is, an ITO or other film can be stacked on the recording layer as by evaporation or sputtering with neither cracking nor a conductivity drop, because the skin layer has been formed on the surface of the recording layer. In this case, it is preferable that the information recording medium is fabricated by providing an electrode on the information recording layer located on a provisional substrate and then removing the provisional substrate from the information recording layer.

An electrode 22 is stacked on a substrate 21 of the information recording medium, and an information recording layer 23 is formed on the electrode. The electrode 22 is formed of the same material as the electrode 12 of the photoelectric sensor already mentioned, and is formed on the substrate 21 in the same stacking manner as already mentioned.

This information recording medium is opposed to the above photoelectric sensor, with a spacer 16 interposed between them, as shown in FIG. 7, and both electrodes 12 and 22 are connected to each other through a voltage source V, thereby constructing a first information recording system. In this system, at least one of the electrodes 12 and 22 may be transparent.

The spacer is preferably formed using a resin film such as that of polyester such as polyethylene terephthalate, polyimide, polyethylene, polyvinyl chloride, polyvinylidene chloride, polyacrylonitrile, polyamide, polypropylene, cellulose acetate, ethyl cellulose, polycarbonate, polystyrene or polytetrafluoroethylene. It may also be formed by the coating and drying of a solution containing one of the above resins. Alternatively, the spacer may be formed by the evaporation of a metal material such as aluminum, selenium, tellurium, gold or platinum, or an inorganic or organic compound. Spacer thickness defines an air gap distance between the photoelectric sensor and the information recording medium and has an influence on the distribution of the voltage applied to the information recording layer, and so is preferably up to 100 μm, more preferably 3 μm to 30 μm.

As mentioned above, the information recording system of the present invention may be constructed by arranging the photoelectric sensor and information recording medium with a gap located between them. Alternatively, it may be constructed by stacking the photoelectric sensor directly on the information recording medium. Still alternatively, it may be of a one-piece type constructed by forming an insulating dielectric layer on the photoconductive layer of the photoelectric sensor and then forming the information recording layer and upper electrode thereon.

The dielectric layer is preferably formed by stacking an inorganic material such as SiO₂, TiO₂, CeO₂, Al₂O₃, GeO₂, Si₃N₄, AlN or TiN on the photoconductive layer by suitable techniques such as evaporation, sputtering or chemical vapor deposition (CVD), or alternatively stacking on the photo-conductive layer an aqueous solution of a water-soluble resin less compatible with an organic solvent, e.g., polyvinyl alcohol, aqueous polyurethane or water glass by suitable coating techniques such as spin coating, blade coating or roll coating. Additionally, use may be made of a fluoro-carbon resin that can be coated on the photoconductive layer. In this case, a solution of the fluorocarbon resin in a fluorine type solvent may be coated on the photoconductive layer by spin coating or stacked on the photoconductive layer as by blade or roll coating.

For the fluorocarbon resin that can be coated on the photoconductive layer, it is preferable to use a fluorocarbon resin disclosed in JP-A 1-131215 or an organic material capable of forming a film in a vacuum system, e.g., poly-para-xylene.

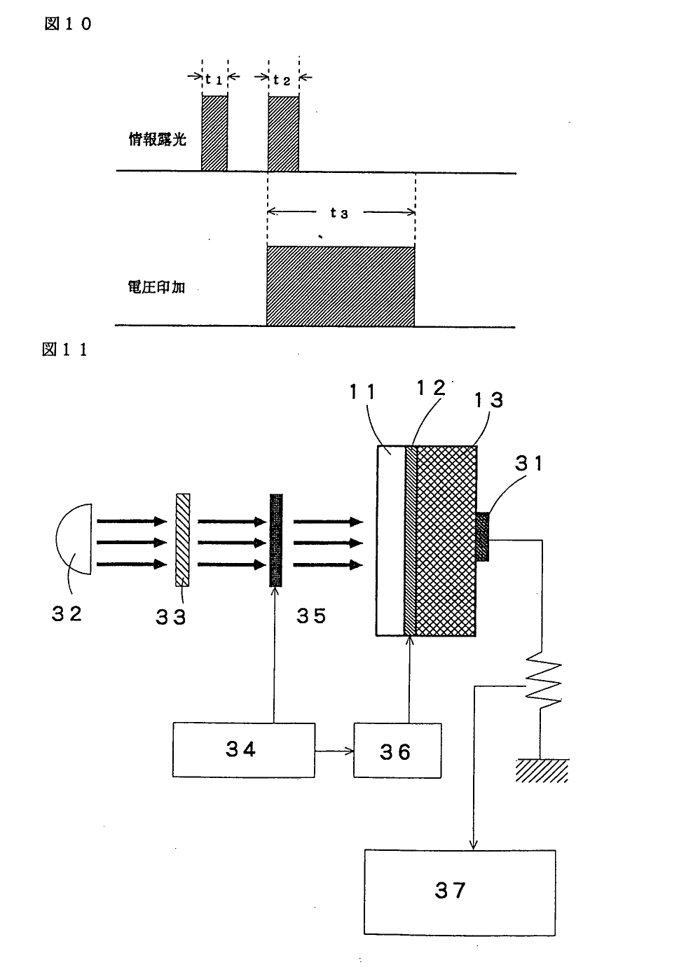

The method of recording information on the information recording system according to the present invention will now be explained with reference to an arrangement wherein the photoelectric sensor and information recording medium are arranged with a gap located between them. FIG. 8 is a view that illustrates the method of recording information using the photoelectric sensor of the present invention.

As illustrated, the information recording system includes a controller 18 designed to control the application of voltage such that voltage is applied between the electrodes 12 and 22 upon exposure of the photoelectric sensor to information light 17, voltage is intermittently fed to the electrodes 12 and 22 during exposure of the photoelectric sensor to information light 17, or voltage is again applied to the electrodes 12 and 22 upon the finish of application of voltage. Photocarrier generated in the portion of the photoconductive layer (consisting of the carrier generation and transport layers 14 and 15) on which the light is incident are moved by an electric field created by both the electrodes, so that the redistribution of the voltage can occur. This in turn causes the liquid crystals in the liquid crystal phase of the information recording layer to be so aligned that information can be recorded on the information recording layer according to the pattern of information light 17. It is here to be understood that while the information light 17 is incident on the photoelectric sensor, voltage may be applied to the electrodes for a given time.

The operation voltage and its range vary with liquid crystals. Thus, when the voltage to be applied and the voltage applying time are to be predetermined, it is preferable to make proper determination of the voltage distribution in the information recording medium so that the voltage distributed to the information recording layer can be set within the operating voltage range of the liquid crystal used. This recording method makes planar analog recording and liquid crystal level recording possible, and enables information to be recorded with high resolution. The exposure pattern is retained in the form of a visible image by the alignment of the liquid crystals in the liquid crystal phase.

A camera or laser may be used for recording information. When the camera is used, an information recording medium is used in place of photographic film used with an ordinary camera. In this case, either an optical shutter or an electrical shutter may be used. For color photography, light information is separated through a combined prism and color filter into R, G and B light components in the form of parallel beams, which are in turn recorded on three R, G and B information recording media to form one frame. Alternatively, the R, G and B images may be recorded on three different regions of one information recording medium to form one frame.

For the laser recording mode, argon laser (514.488 nm), helium-neon laser (633 nm) and semiconductor laser (780 nm, 810 nm, etc.) may be used as light sources. Exposure of the photoelectric sensor to laser is achieved by scanning, corresponding to image, character, code or line drawing signals. Image or other analog recording is achieved by modulating the intensity of laser light, while digital recording, like character, code or line drawing recording, is achieved by on/off control of laser light. An image comprising an array of halftone dots is formed by placing laser light under on/off control using a dot generator.

Upon removal of the information recording medium, the light information recorded thereon is reproduced by transmitted light. At the information-recorded portion the liquid crystals are so aligned in the direction of the electric field that light can be transmitted through it, whereas at the portion with no information recorded light is scattered, so that both portions can be in good contrast with each other. The information recorded on the recording information system may also be read by reflected light.

The information recorded by the alignment of the liquid crystals is visibly readable information, which may be magnified through a projector. If laser scanning or a CCD is used, this information may then be read by transmitted or reflected light with high precision. If required, light scattering may be avoided by use of schlieren optics.

The information recording medium of the information recording system according to the present invention is designed to record electrostatic information by liquid crystal alignment in a visible form. By selection of a suitable combination of liquid crystals with resin, the information once made visible by liquid crystal alignment is not made to vanish or remain memorized. Upon heated to a high temperature in the vicinity of the isotropic phase transition temperature, the thus memorized information can vanish, so that the information recording layer can be again used for recording information.

The photoelectric sensor of the present invention is well fit for recording information on an information recording system including an information recording layer formed of a liquid crystal-polymer composite material, as mentioned above, but may be applied to other information recording media as well. These information recording media, for instance, may be an electrostatic information recording medium including an information recording layer formed of an insulating layer of resin excellent in charge retainability such as fluorocarbon resin, wherein information is stored in the form of electrostatic charges and electrostatic information is reproduced by toner development or potential reading, as typically set forth in JP-A 4-70842, JP-A 4-46347, JP-A 3-7942 and JP-A 4-73769, and an information recording medium including an information recording layer formed of a thermoplastic resin layer wherein, as mentioned just above, information is stored on the surface in the form of electrostatic charges so that it can be stored by heating in the form of a frost image, and the thus stored information is reproduced in the form of a visible image, as typically disclosed in JP-A 3-170985, JP-A 3-170984 and JP-A 3-192288.

In its as-made state, the photoelectric sensor according to the present invention cannot be used for the recording method according to the present invention, because it has no semi-conductivity in that state. To allow the photoelectric sensor to be used according to the present invention, it must be allowed to stand alone for a given time or longer. This then enables the photoelectric sensor to show semi-conductivity even in a dark place. Prior to use, the whole surface of the photoelectric sensor may otherwise be uniformly exposed to a sufficient quantity of light.

With the photoelectric sensor of the present invention, it is possible to record information with good-enough contrast by varying the voltage application and exposure start points, even when it is exposed to light of low intensity. It is also possible to record information at the optimum applied voltage within the optimum voltage applying time, because the time at which the potential applied to the liquid crystal recording layer reaches a maximum varies depending on the voltage application and exposure start points.

In the photoelectric sensor of the present invention, there is a conductivity difference between the exposed and unexposed portions depending upon voltage applying modes, one mode wherein after voltage is applied to the sensor upon, or at the same time, exposure of the sensor to light, the application of voltage to the sensor is interrupted and then resumed, and another mode wherein after voltage is applied to the sensor upon, or at the same time, exposure of the sensor to light, the application of voltage of opposite polarity is followed by the application of voltage. On the other hand, when the photoelectric sensor is exposed to light to resume the application of voltage while the application of voltage is interrupted or the voltage of opposite polarity is applied to the sensor, the conductivity of the exposed portion is increased, as in the case where the application of voltage is continued.

By repeating the application of voltage it is also possible to record image information with high-enough contrast. By the first application of voltage with exposure of the sensor to light, the voltage of the unexposed portion of the liquid crystal recording layer has the threshold value, so that the voltage of the liquid crystal recording layer can be lowered either by interrupting the application of voltage just after the liquid crystal alignment starts, or the application of a voltage lower than the first applied voltage or a voltage of opposite polarity. After an elapse of some time in this state, voltage is again applied to the sensor and the application of the voltage is continued until the voltage of the unexposed portion has the threshold value. In the state where the application of voltage is interrupted or the voltage of opposite polarity is applied to the sensor, the voltage of opposite polarity is often applied to the sensor. By resuming the application of voltage, however, much more voltage can be applied to the exposed portion of the liquid crystal recording layer to enable information to be recorded thereon, because there is a conductivity difference between the unexposed and exposed portions.

An example of the change of the voltage applied to the liquid crystal recording layer and photoelectric sensor by the repeated application of voltage is shown in FIG. 9 with reference to an information recording system wherein the photoelectric sensor is opposed to the information recording medium with an air gap located between them. However, it is to be understood that even with an information recording system wherein the photoelectric sensor and liquid crystal recording medium are stacked one upon another with or without a dielectric interlayer located between them, it is possible to record information by the same voltage applying method as mentioned above.

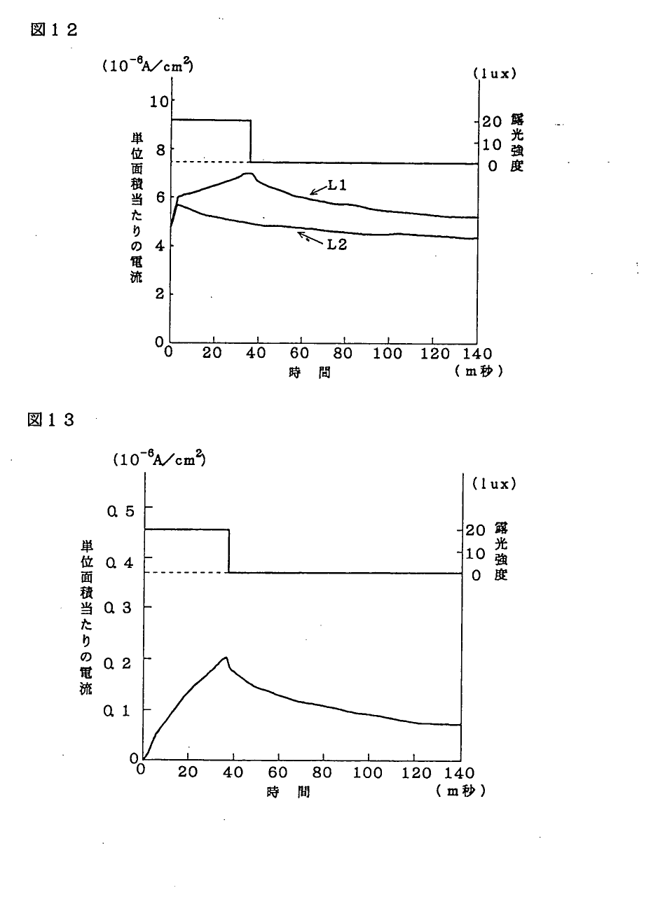

An account will now be given of how to record at least two items of image information by multiple exposure, using the photoelectric sensor. FIG. 10 illustrates how to record two items of image information. The photoelectric sensor is exposed to one image light for a time t1 prior to applying voltage thereto, and voltage is applied to the photoelectric sensor for a time t3 simultaneously with exposure of the sensor to another image light for a time t2. In this way, at least two items of information such as a picture and characters can be superposed one upon another in the form of one image. Thus, at least two items of image information may be recorded on the same position of the liquid crystal recording medium while they are superposed one upon another, or they may be recorded on discrete positions of the liquid crystal recording medium.

By recording plural items of image information in a single voltage applying operation, the second image information can be recorded without putting the first recorded image information out of order. Although no limitation is placed on the number of image information to be superposed one upon another, it is required that image recording be made within a relatively short period of time, because the first recorded image information often vanishes when the time interval between the first and second recording step is too long.

Since image information decays with time, it is required to regulate or control exposure time, etc., so as to record each image information at equal intensity.

To record information such as an image or characters by means of laser, the photoelectric sensor is scanned with laser light. By scanning the photoelectric sensor with laser light while it is opposed to the liquid crystal recording medium, it is possible to write image or character information on the photoelectric sensor. After writing has been finished, voltage is applied between the two electrodes of the photoelectric sensor and liquid crystal recording medium, so that the image can be recorded on the liquid crystal recording layer. When laser light is used, it is prima facie possible to thermally write information on the liquid crystal recording medium, but a problem with thermal writing is that no image of high resolution can be written on the liquid crystal recording medium due to heat diffusion. However, if information is written on the photoelectric sensor and recorded on the liquid crystal recording medium with the application of voltage, it is then possible to achieve a recorded image of high resolution.

### Example 1

An ITO film of 100 nm in thickness was sputtered on a well washed glass substrate of 1.1 mm in thickness to obtain an electrode layer.

Then, 3 parts by weight of a bisazo pigment of the structure given below, 0.75 parts by weight of a vinyl chloride-vinyl acetate copolymer, 0.25 parts by weight of polyvinyl acetate, 98 parts by weight of 1,4-dioxane and 98 parts by weight of cyclohexanone were mixed together and dispersed in each other in a paint shaker for 6 hours to prepare a coating solution. The coating solution was spin-coated on the above electrode layer at 1,400 rpm for 0.4 seconds, and then dried at 100° C. for 1 hour to obtain a carrier generation layer of 300 nm in thickness.

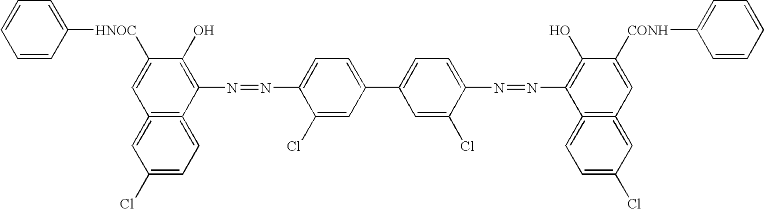

A coating solution obtained by mixing together 1 part by weight of a carrier transport substance or a compound of the following structure, 4 parts by weight of polystyrene resin, 22 parts by weight of 1,1,2-trichloromethane and 14 parts by weight of dichloromethane was spin-coated on the above carrier generation layer at 400 rpm for 0.4 seconds, and dried at 80° C. for 2 hours to obtain a carrier transport layer. In this way, there was obtained a photoelectric sensor including a 20-μm thick photoconductive layer consisting of the carrier generation and transport layers. The thus fabricated photoelectric sensor was used after aged at a relative humidity of 60% or less in a dark place for 3 days.

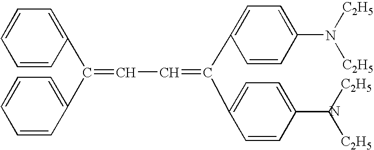

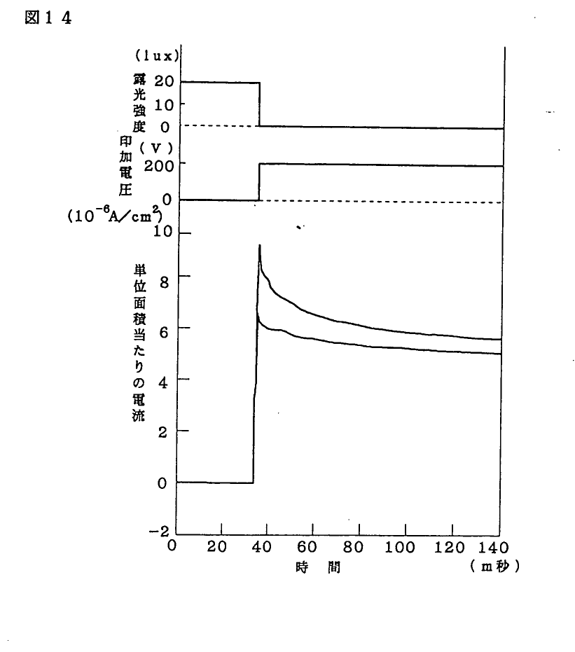

How to measure the characteristics of the photoelectric sensor according to the present invention is illustrated in FIG. 11. The photoelectric sensor 10 includes a transparent electrode 12 on a substrate 11. The transparent electrode includes thereon a photoconductive layer 13 consisting of carrier generation and transport layers, and the photo-conductive layer includes thereon a gold electrode 31 over an area of 0.16 cm². Green light from a light source 32 through a filter 33 is directed to the photoelectric sensor 10 through a shutter 35 the clicking of which are controlled by a pulse generator 34. The pulse generator also controls the voltage and voltage applying time of a power source 36, which applies direct current between the gold electrode 31 and the transparent electrode 12 such that the transparent electrode is of positive polarity. A voltage across a resistance connected to the gold electrode was used to measure a photo-induced current on an oscilloscope 37.

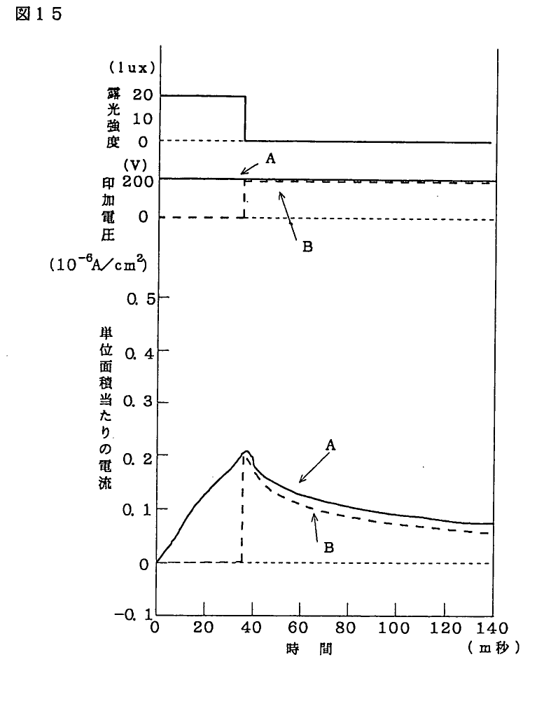

At the same time as the start of a 33-millisecond exposure at an exposure intensity of 20 luxes, a voltage of 200 volts is applied to the photoelectric sensor. The resulting current L1 (light current) passing through the photoelectric sensor is shown in FIG. 12 together with a current L2 passing through the photoelectric sensor when it is exposed to no light, and a photo-induced current represented by a difference between the light and dark currents is shown in FIG. 13. The photo-induced current continues to increase during exposure, and decays gently at the applied voltage even after the exposure has been finished; in other words, this current continues to flow over a sufficient period of time.

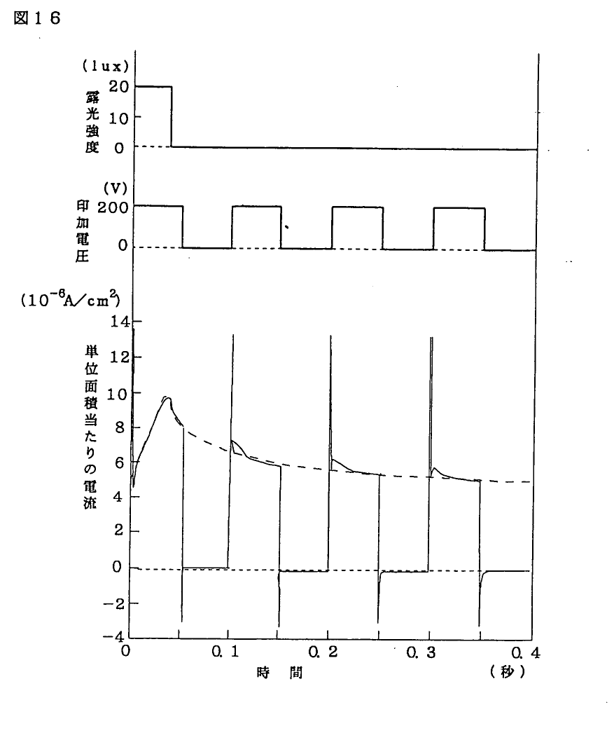

Referring now to FIG. 14, there are shown the light and dark current data obtained when there is a time lag between the voltage application start point and the exposure start point. As in the case of FIG. 12, the exposure time and intensity were 20 luxes and 33 msec., but a voltage of 200 volts was applied to the photoelectric sensor at the same time as the exposure thereof to light was finished. FIG. 14 reveals that when the exposure of the photoelectric sensor to light is finished before the voltage is applied thereto, there is a conductivity difference between the exposed and unexposed portions.

The photo-induced current data obtained when the photoelectric sensor is exposed to light at an applied voltage according to the above-described two methods are shown in FIG. 15. In both methods the photoelectric sensor was exposed to 20-lux light for 33 msec., but in one method (A) a voltage of 200 volts was applied thereto at the same time as the start of exposure, while in another method (B) a voltage of 200 volts was applied thereto at the same time as the finish of exposure. The photo-induced current represented by the difference between the light and dark currents is independent on the exposure and voltage application start points; that is, it is dependent on the exposure time, and so has a substantially equal value at the applied voltage. It is thus unnecessary to apply voltage to the photoelectric sensor at the same time as the start of exposure or just after the finish of exposure. In other words, even when voltage is applied to the photoelectric sensor during exposure or after an elapse of some time from the finish of exposure, similar results are obtainable.

In this example, the photo-induced current is described as having an almost equal value, but the photo-induced current is not always required to have an equal value; in some cases, the photo-induced current varies depending on the exposure and voltage application start points. Even in such cases, the photoelectric sensor in which the exposed portion becomes higher in conductivity than the unexposed portion when voltage is applied thereto after the finish of exposure can be used with the information recording method of the present invention.

### Example 2

The characteristics of the photoelectric sensor were measured following Example 1 with the exception that voltage was applied thereto as follows.

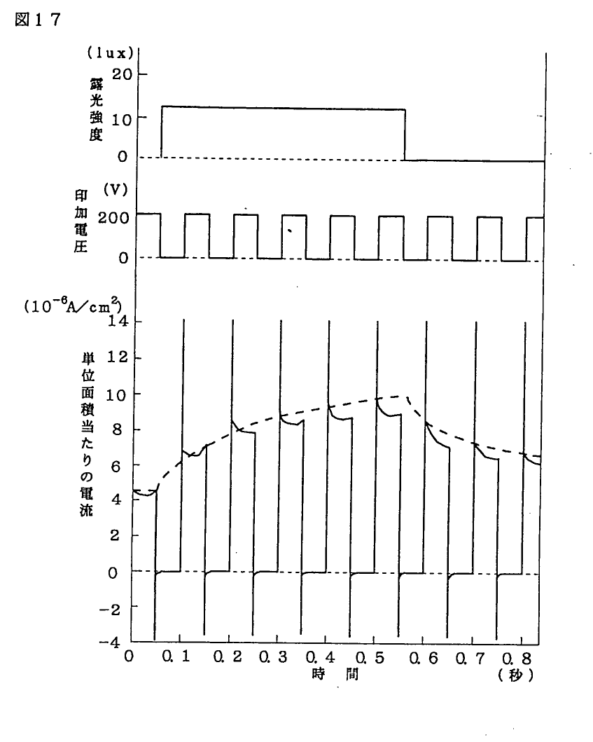

The photoelectric sensor was exposed to 20-lux light for 33 milliseconds at a constant applied voltage of 200 volts, and at a rectangular wave form of applied voltage of 200 volts. The resulting current data are shown in FIG. 16. The application of the rectangular wave to the sensor was carried out every 50 msec.

The currents obtained at the constant applied voltage are shown by broken lines, and the currents obtained at the rectangular wave form of applied voltage by solid lines.

At no applied voltage no current flows. Either at the constant applied voltage of 200 volts or at the rectangular wave or pulse form of applied voltage of 200 volts, however, the currents have an almost equal value. Even in the cycle in which the finish of the application of voltage is followed by resuming the application of voltage, the obtained currents have substantially the same value as in the case where the application of 200 volts is continued.

In the above example, the voltage is described as being zero while the pulse form of voltage is applied to the photoelectric sensor. Even when voltage of opposite polarity is applied to the sensor while the pulse form of voltage is applied thereto, however, the current has a value equal to that obtained when a constant voltage is applied thereto, if the voltage of 200 volts is applied thereto as mentioned above. Where the voltage of opposite polarity is applied to the sensor, a current of opposite polarity flows there-through. In this case, there is no conductivity difference between the exposed and unexposed portions.

As mentioned above, the photoelectric sensor, when designed such that either when a constant voltage is applied thereto or when a pulse form of voltage is applied thereto, the current measured has an almost equal value, can be used with the information recording method according to the present invention. The photoelectric sensor, even when designed such that whether during exposure or after the finish of exposure, the exposed portion is different from, and higher than, the unexposed portion in terms of conductivity, may also be used with the information recording method of the present invention.

### Example 3

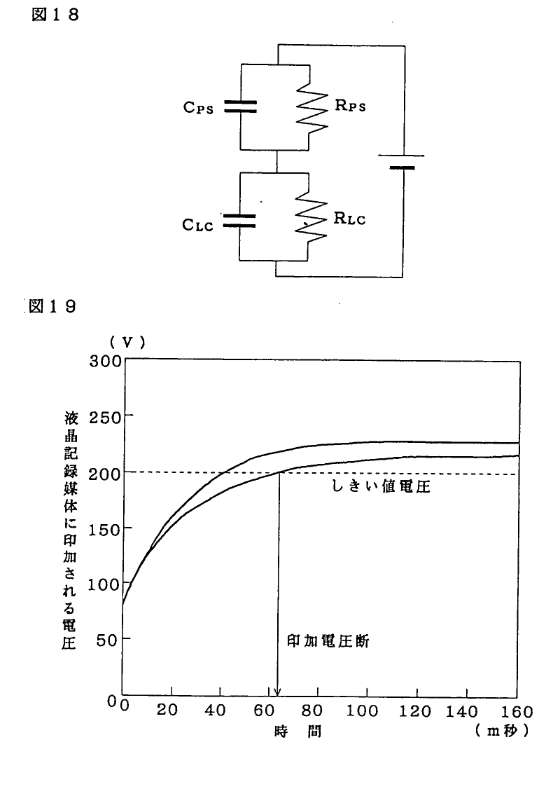

The photoelectric sensor was exposed to 12-lux light for an exposure time of 500 msec. In FIG. 17, the current obtained when a constant voltage of 200 volts was continuously applied thereto as in Example 2 is shown by a broken line, and the current obtained when the application of a rectangular wave form of voltage thereto was continued for 50 msec., and then interrupted for 50 milliseconds by a solid line. As in Examples 1 and 2, the photo-induced current continues to increase during exposure in the state where a constant voltage is applied to the sensor. When the rectangular wave voltage in a pulse form is applied to the sensor, however, the photo-induced current is found to increase during exposure even at an applied voltage of 0 volt.

### Example 4

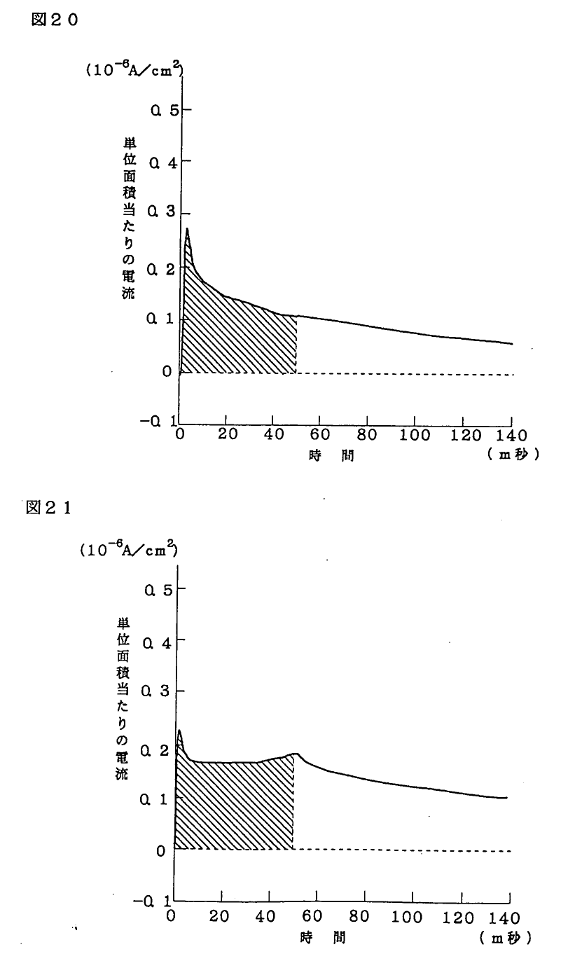

The photoelectric sensor was used with a liquid crystal recording medium functioning as the information recording medium. The ability of the sensor to record information in this case was measured. As shown in FIG. 18, the liquid crystal recording medium may be expressed as a parallel circuit consisting of a resistance (R_{LC}) and a capacitor (C_{LC}), and the optical sensor may be expressed as a parallel circuit consisting of a resistance (R_{PS}) and a capacitor (C_{PS}) as well. The photoelectric sensor had a thickness of 10 μm, the liquid crystal recording medium had a capacity of 1,000 pF/cm² and an electrical resistance of 120 MΩ, and the spacing between the photoelectric sensor and liquid crystal recording medium was 10 μm. The photoelectric sensor was exposed to 20-lux light for 1/30 seconds while 730 volts were applied between the electrode of the sensor and the electrode of the liquid crystal recording medium. The results found from the obtained data are shown in FIG. 19.

Just after the application of voltage, the voltage is distributed according to the capacity ratio of the photo-electric sensor and liquid crystal recording medium. Thereafter, this voltage distribution varies due to the resistance components of the photoelectric sensor and liquid crystal recording medium, resulting in an increase in the voltage of the liquid crystal recording medium. Because the photoelectric sensor varies in conductivity between the exposed and unexposed portions, much more voltage is applied to the liquid crystal recording medium at the exposed portion than at the unexposed portion.

At higher than the threshold voltage, the liquid crystal recording medium increases in transmittance because the liquid crystals are excessively aligned in the direction of the electric field. Consequently, the voltage of the liquid crystal recording medium reaches the threshold voltage more earlier at the exposed portion than at the unexposed portion. Thus, when the application of voltage is interrupted upon the voltage of the unexposed portion reaching the threshold value at which the liquid crystals start to align, the exposed portion to which a voltage higher than the threshold value has been applied so that the liquid crystals have been aligned differs from the unexposed portion in terms of transmittance, and this state is maintained even after the finish of the application of voltage so that information can be recorded thereon.

### Example 5

The photo-induced current represented by the difference between the light and dark currents was measured following Example 2 with the exception that the photoelectric sensor was exposed to 6-lux light for 200 msec., and a voltage of 200 volts was then applied thereto simultaneously with the finish of exposure. The results are shown in FIG. 20, in which the hatched region shows the photo-induced current for 50 milliseconds after the start of the application of voltage effective for recording information on the liquid crystal recording medium.

### Example 6

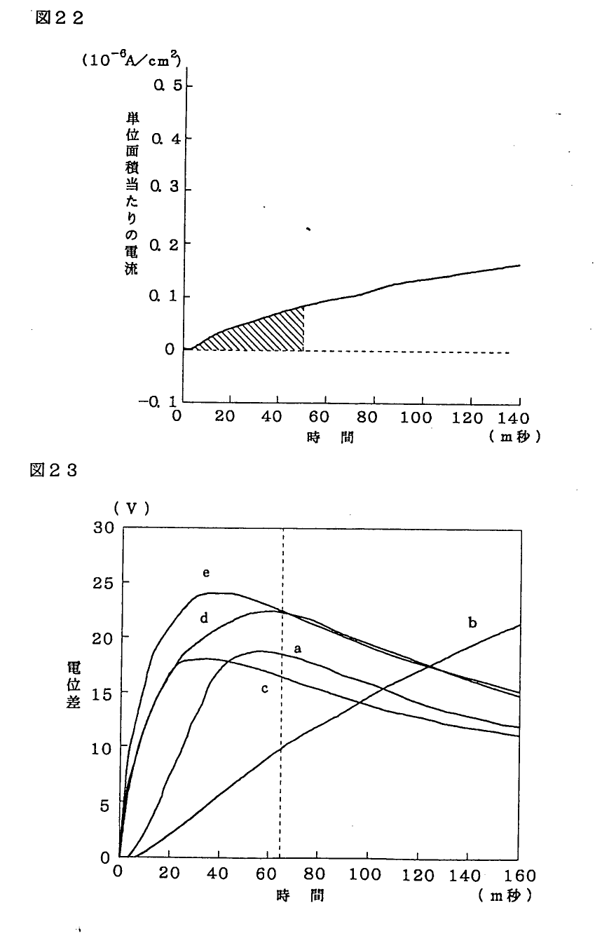

The photo-induced current represented by the difference between the light and dark currents was measured following Example 5 with the exception that the photoelectric sensor was exposed to 6-lux light for 200 msec., and a voltage of 200 volts was then applied thereto 150 milliseconds after the start of exposure. The results are shown in FIG. 21, in which the hatched region shows the photo-induced current for 50 milliseconds after the start of the application of voltage effective for recording information on the liquid crystal recording medium.

### Comparative Example 1

The photo-induced current represented by the difference between the light and dark currents was measured following Example 5 with the exception that the photoelectric sensor was exposed to 6-lux light for 200 msec., and a voltage of 200 volts was then applied thereto at the same time as exposure. The results are shown in FIG. 22, in which the hatched region shows the photo-induced current for 50 milliseconds after the start of the application of voltage effective for recording information on the liquid crystal recording medium.

By exposure for an extended time it is possible to obtain a photo-induced current equivalent to that obtained by exposure at a light intensity of 20 luxes for 33 msec. However, the area of the hatched region showing the photo-induced current for 50 milliseconds after the start of the application of voltage is smaller than that of Example 5 or 6 wherein the photoelectric sensor is exposed to 20-lux light, and this indicates that no image of good-enough contrast can be recorded on the recording medium.

### Example 7

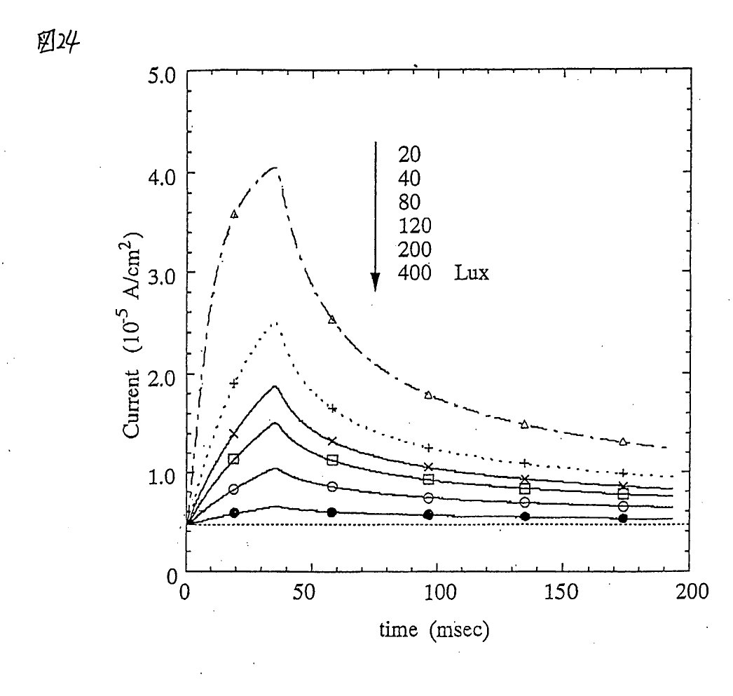

As in Example 4, the voltage applied to the liquid crystal recording medium was calculated, and the voltage difference between the exposed and unexposed portions was simulated. The results are shown in FIG. 23, wherein a represents the case where the photoelectric sensor was exposed to 20-lux light for 33 msec., and voltage was applied to the electrodes at the same time as the exposure, b Comparative Example 1, c Example 5, d Example 6, and e the case where the photoelectric sensor was exposed to 6-lux light for 200 msec., and voltage was applied to the electrodes 175 milliseconds after the start of exposure.

Given that the threshold voltage of the liquid crystal recording medium is 200 volts, the voltage of the liquid crystal recording medium at the unexposed portion reaches the threshold voltage in about 65 msec. By interrupting the application of voltage within this time, it is therefore possible to record information. By comparing the potential differences of the light and dark portions in this case, it is possible to make estimation of the contrast after information has been recorded on the recording medium. From FIG. 23, it is found that no striking contrast is obtained in the case of b, because the potential difference of b is about half of that of a after an elapse of 65 msec. However, the potential differences obtained in c, d and e are almost equal to or higher than that obtained in a. The cases d and e show a virtually equal potential difference after an elapse of 65 msec. By making the applied voltage in e higher than that in d and recording information for a voltage applying time of about 30 msec, however, it is possible to record information with a more striking contrast.

Reference will now be made to the recording method of the present invention wherein the time from the start of exposure of the photoelectric sensor to image light to the start of application of voltage to the electrodes is varied, thereby changing the latitude of the recorded image.

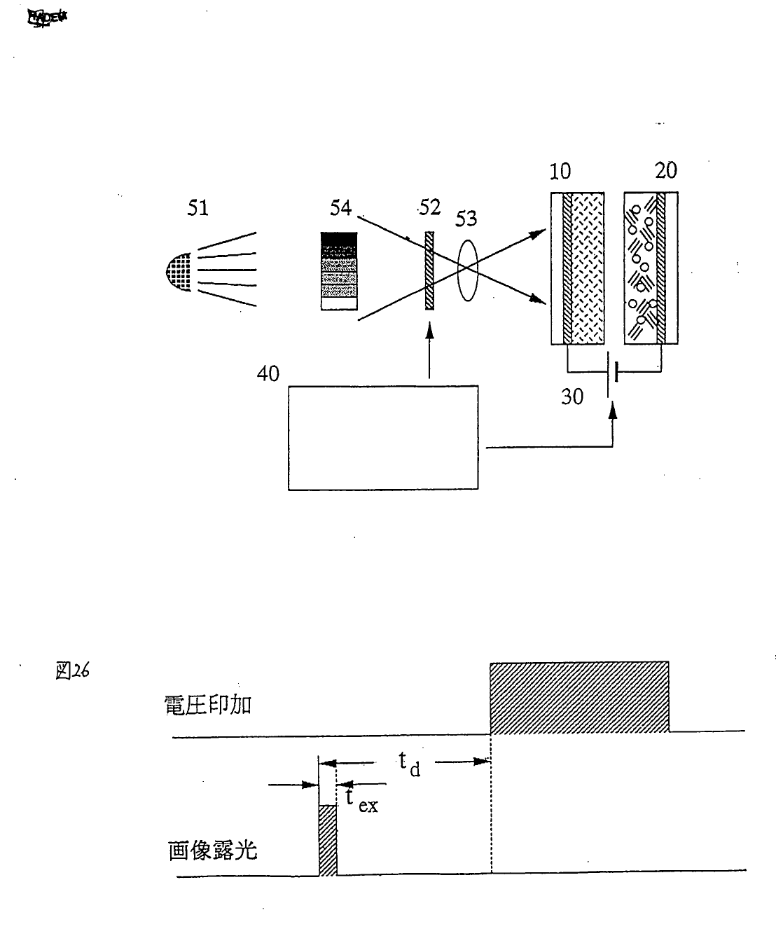

The photoelectric sensor of the present invention was exposed to image light at a varying exposure intensity while voltage was applied to the electrodes. The resulting photo-induced currents are shown in FIG. 24. The exposure time was likewise 33 msec. The exposure intensity was Δ=400 luxes, +=200 luxes, X=120 luxes, [symbol] =80 luxes, ◯=40 luxes, and •=20 luxes.

The photo-induced current continues to increase during exposure, and reaches a maximum after an elapse of 33 msec. At this time the photo-induced current is dependent on light intensity; the higher the light intensity, the larger the photo-induced current. Upon exposure, the photo-induced current decays, but the higher the exposure intensity, the higher the decay rate, and the lower the exposure intensity, the lower the decay rate. The proportion of the photo-induced current at a low exposure intensity to the photo-induced current at a high exposure intensity is lower after an elapse of a certain time upon exposure than just after the finish of exposure.

In the image recording method of the present invention, the liquid crystals are aligned depending on the magnitude of such a photo-induced current. From the results shown in FIG. 24, it is expected that when voltage is applied to the electrodes after an elapse of some time upon the finish of exposure of the photoelectric sensor to image light, it is possible to reduce a difference in the alignment of liquid crystals between portions exposed to light at low and high exposure intensities. In other words, it is expected that the latitude of exposure can be made wide.

FIG. 25 illustrates one construction of the image recording system for varying exposure latitude. In this image recording system, the photoelectric sensor 10 of the present invention is opposed to the liquid crystal recording medium 20 of the present invention with a gap located between them, using as the spacer a polyimide film of about 9 μm in thickness. The image recording system enables the photoelectric sensor 10 to be exposed to the transmitted image of a color transparency 54, using a power source 51, a lens 53 and a shutter 52. By use of a control circuit 40 of the image recording system, it is possible to control the power source 30 and shutter 52 and thereby expose the sensor to the image at any desired time. By use of the light source 30, it is possible to apply voltage between the two electrodes at any desired time. It is also possible to optionally vary the timings of applying voltage to the electrodes and exposing the sensor to the image.

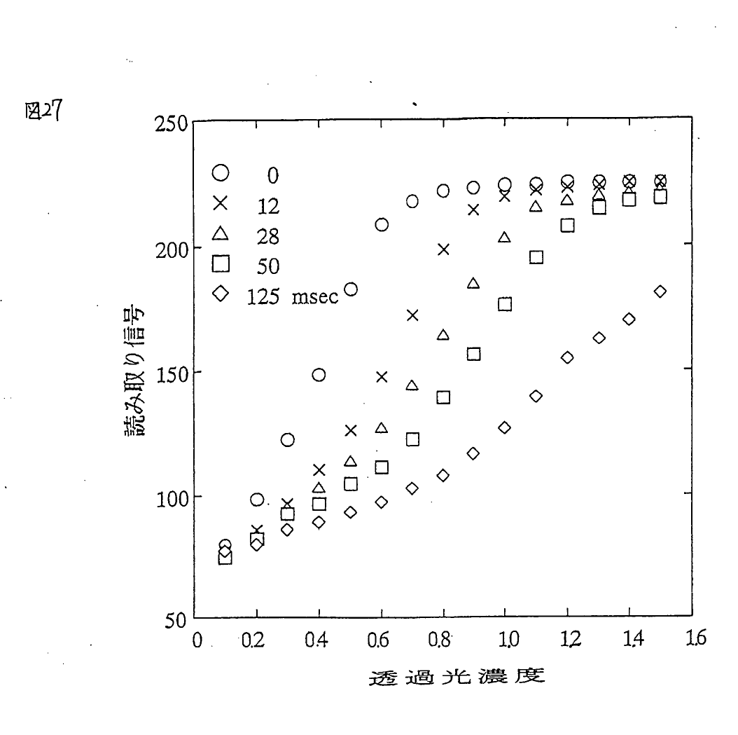

Used for the color transparency was a gray scale with the optical density changing by an increment of 0.1 for each step. An account will now be given of the timings of applying voltage to the electrodes and exposing the sensor to the image according to this example with reference to FIG. 26. Here let tₑₓ and t_{d} represent the time of exposure of the sensor to the image and the period of time from the start of exposure of the sensor to the image to the start of application of voltage to the electrodes, respectively. The image was recorded at a varying time t_{d} of 0 to 125 milliseconds under otherwise identical conditions. The recording conditions at this time were the exposure time= 1/125 seconds, the applied voltage=750 volts, and the voltage applying time=50 msec.

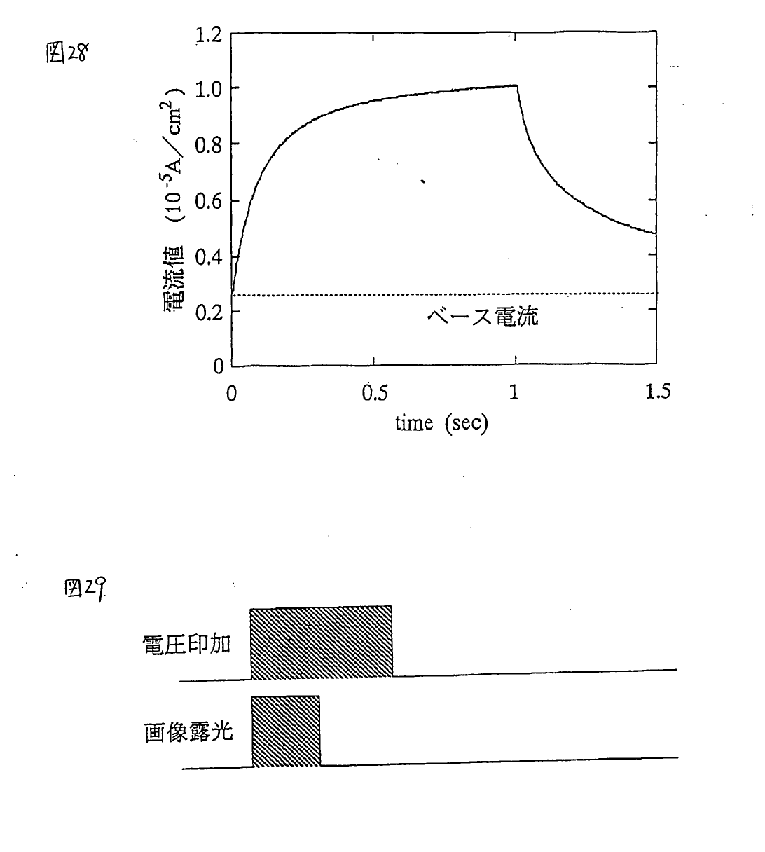

Under these conditions the image was recorded. The liquid crystal recording medium 20 with the image recorded thereon was irradiated with reading light to read the transmitted light by a CCD sensor. FIG. 27 is an exposure quantity (gray scale step) vs. read signal plot. In FIG. 27, ◯ is t_{d}=0, X is t_{d}=12 msec., Δ is t_{d}=28 msec., [symbol] is t_{d}=50 msec., and is t_{d}=125 msec.

From FIG. 27, it is seen that when voltage is applied to the electrodes at the same time as the exposure of the sensor to the image (◯), the step transmission density is saturated at about 0.8, resulting in an image of narrow latitude, but as the period of time from the exposure of the sensor to the image to the application of voltage to the electrodes increases, the saturation density increases, so enabling latitude to be made wide.

By delaying the start timing of application of voltage to the electrodes it is possible to record images under wide latitude conditions. The time t_{d} may be determined depending on the state of the subject to be recorded, and the purpose as well.

Reference will now be made to compensate for a reciprocity law failure in recording images using the image recording system according to the present invention.

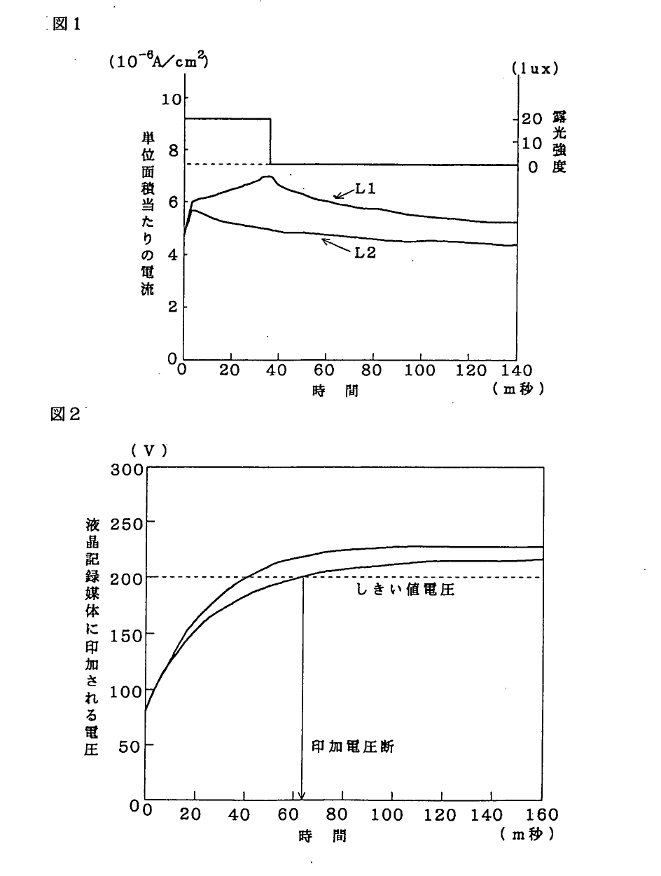

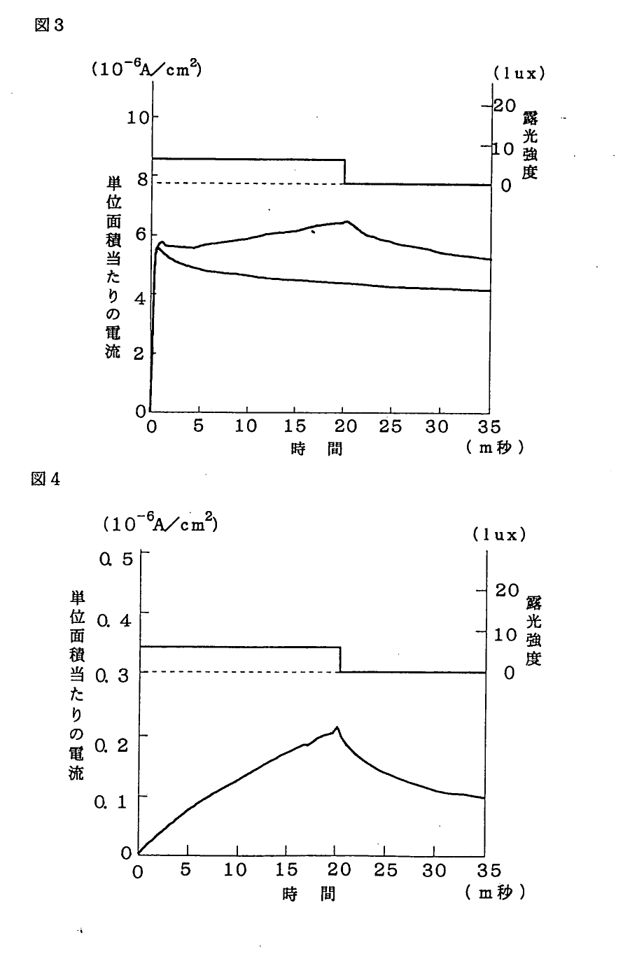

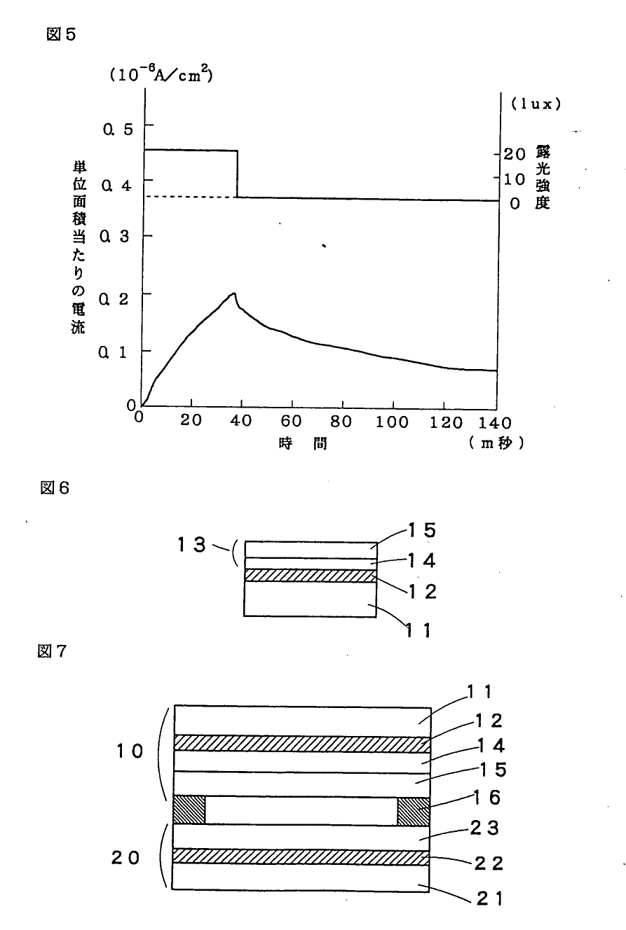

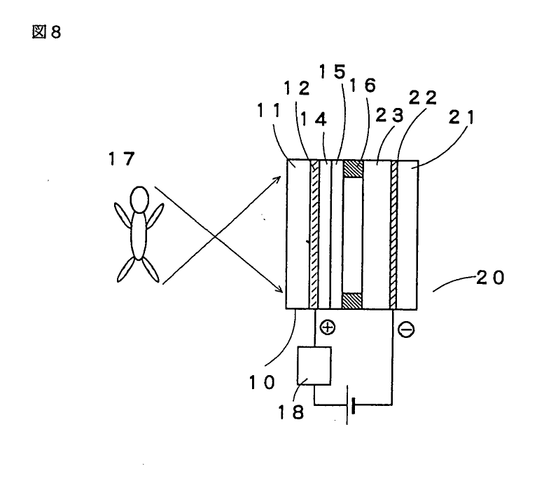

As already explained with reference to FIGS. 1 and 3, the current value of the photoelectric sensor increases simultaneously with the start of exposure of the sensor to light, and decays slowly even after the exposure has been finished; it does not immediately return back to the original state. The current of the photoelectric sensor is not zero even where it is not exposed to light, and is herein called the base current. The photo-induced current is then defined as being a difference between the base current and an actually induced current. By making use of this difference it is possible to record images. Here it should be understood that the photo-induced current has the nature of depending on the base current, and the larger the base current (the higher the conductivity of the photoelectric sensor), the larger the photo-induced current, and the smaller the base current (the lower the conductivity of the photoelectric sensor), the smaller the photo-induced current.

Thus, the system of the present invention makes use of the phenomenon that the photo-induced current continues to flow, albeit decaying slowly, even after the exposure of the sensor to light has been finished. Therefore, the photo-induced current can be effectively used for achieving an improvement in recording sensitivity by allowing the application of voltage to the electrodes to be continued for some time after the finish of the exposure.

As already explained with reference to FIG. 15, it is found that either when the photoelectric sensor is exposed to the image light with voltage applied to the electrodes (A) or when voltage is applied to the electrodes after the exposure of the sensor to the image light has been finished (B), the photo-induced current likewise flows after the start of application of voltage to the electrodes. This appears to be due to a precursor that would have been formed by exposure in the photoelectric sensor by exposure, even with no voltage applied to the electrodes. This precursor is then believed to make the current flow easily through the photoelectric sensor (or lower the resistance value).

The results of the photo-induced current measured at a extremely long exposure time (1 second) are shown in FIG. 28. As can be seen, the photo-induced current increases linearly just after the start of exposure of the sensor to light. After an elapse of about 1 second, however, the photo-induced current reaches a substantial saturation value upon the photo-induced current increase dropping sharply in the vicinity of 200 msec. The tendency shown in FIG. 28 also holds for the precursor.

An account will now be given of how the reciprocity law and reciprocity law failure are measured.

The reciprocity law and reciprocity law failure were measured using the optical system and image exposure system shown in FIG. 25. In this case, the intensity of light incident on the photoelectric sensor was regulated by transmitting light from the light source 40 through an ND filter (not shown) and changing the transmittance of the transmitted light.

The photoelectric sensor was opposed to the liquid crystal medium with an air gap located therebetween, using a film spacer of about 10 μm in thickness. To record an image on the recording medium, the photoelectric sensor was exposed to image light and a voltage of 700 volts was applied from the power source 30 between the electrodes of the sensor and medium for 60 msec. The power source 30 is controlled by the controller 40 so that voltage can be applied to the electrodes at any desired timing in response to the exposure of the sensor to image light.

The reciprocity law failure was measured by changing the exposure intensity and time using such an image exposure system and determining the gradation characteristics, i.e., the relation between exposure quantity and the transmittance of the liquid crystal medium. It is here to be noted that this measurement was done under the same voltage applying conditions, because a change in the voltage applying conditions causes a change in the gradation characteristics.

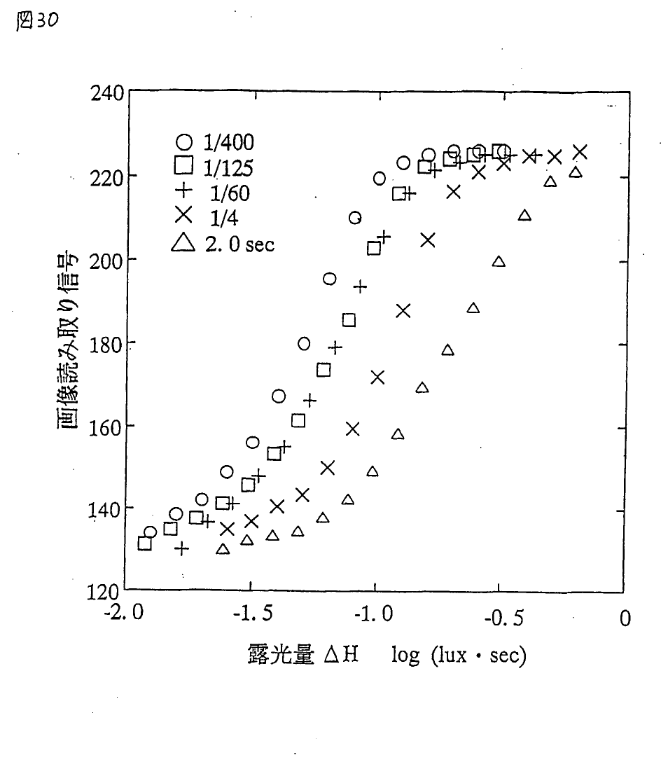

First, the reciprocity law and reciprocity law failure were examined under ordinary image exposure and voltage applying conditions. In an image recording method carried out under ordinary voltage applying conditions, the exposure of the sensor to image light is started at the same time as the application of voltage to the electrodes, and the application of voltage is continued even after the exposure of the sensor to image light has been finished, as illustrated in FIG. 29.

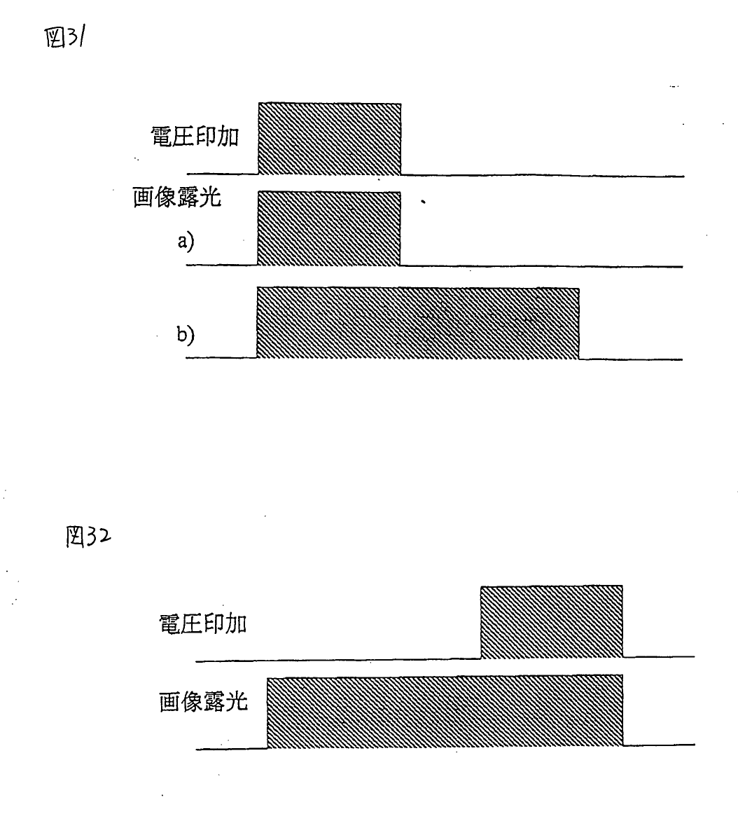

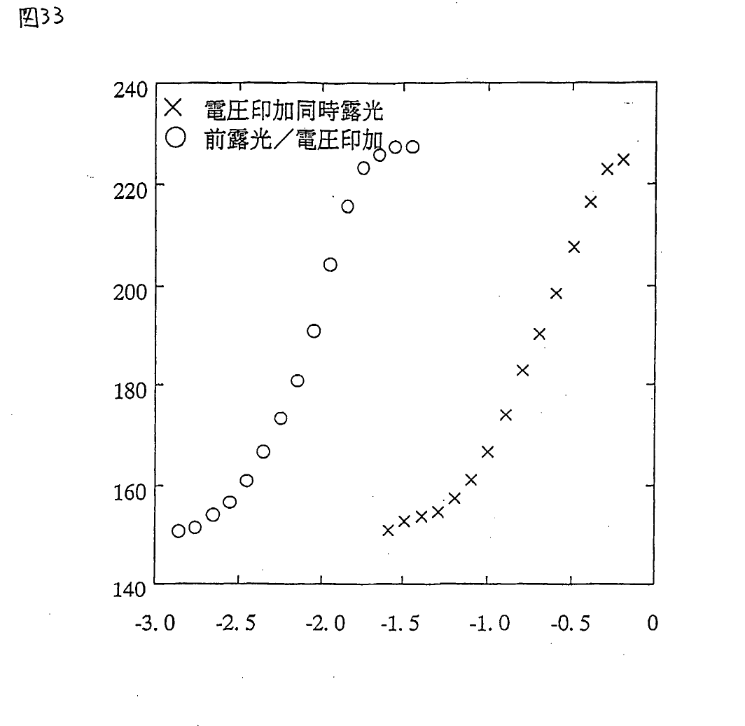

Image recording was done for a voltage applying time of 60 msec., while the exposure intensity was regulated so that the same exposure quantity was obtained at exposure times of 1/400, 1/125, 1/60, 1/30 and 1/15 seconds. The results of the images measured by a specially designed scanner are shown in FIG. 30 with exposure quantity change as abscissa and read signal strength as ordinate. It is here to be noted that only the results obtained at 1/400 seconds (◯), 1/125 seconds ( [symbol] ) and 1/30 seconds (+) are shown in FIG. 30. In FIG. 30, it is also to be noted that the exposure times of ¼ seconds (x) and 2.0 seconds (Δ) imply that the sensor was exposed to light at the same voltage applying time but prior to the start of application of voltage to the electrodes, as explained later with reference to FIG. 32.

Within the range of 1/125 to 1/30 seconds, the gradation characteristic curves overlap each other, indicating that the reciprocity law is satisfied. In 1/400 seconds the characteristic curve is slightly shifted to the low intensity side.

When the exposure time is shorter than the voltage applying time, it is possible to make effective use of the photo-induced current by allowing the application of voltage to the electrodes to be continued even after the exposure of the sensor to light. In 1/15 seconds, however, the voltage applying and exposure method shown in FIG. 31(a) wherein the exposure time is nearly equal to the voltage applying time must be used. Thus, the reciprocity law fails (a reciprocity law failure), because it is impossible to make effective use of the photo-induced current and so the characteristic curve is shifted to the high intensity side.

When the photoelectric sensor is exposed to light for a time longer than 1/15 seconds, i.e., when the voltage applying and exposure method shown in FIG. 31(b) is used, the step of exposing the sensor to light after the finish of application of voltage becomes entirely useless. In this region, the reciprocity law thus fails, because the longer the exposure time, the more likely is the characteristic curve to be shifted to the high intensity side.

Explanation will now be offered as to how to compensate for the reciprocity law failure.

### Method for Compensating for the Reciprocity Law Failure in a Region where Exposure Time is Long

A first account will be given of the method for compensating for the reciprocity law failure in a region where exposure time is long.

As already explained, the photoelectric sensor used with the system of the present invention has the property of, even when it is exposed to image light with no voltage applied to the electrodes, generating the photo-induced current by applying voltage to the electrode later. It is this property that is used for exposing the sensor to light for an extended period of time. As illustrated in FIG. 32 as an example, the exposure of the sensor to image light is started prior to the application of voltage to the electrodes. Then, the exposure of the sensor to image light is finished prior to or at the same time as the finish of the application of voltages to the electrode, whereby any useless consumption of light can be avoided prior to the start of the application of voltage to the electrodes.

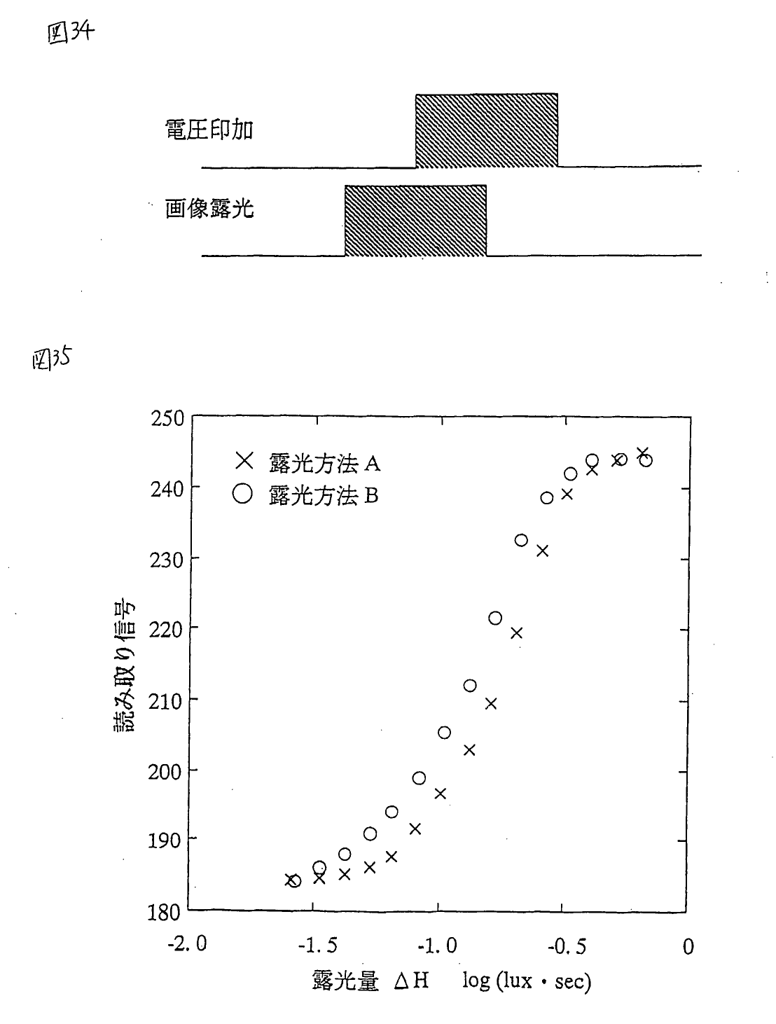

The photoelectric sensor was exposed to image light at the same time as the application of voltage to the electrodes as shown in FIG. 31, and the photoelectric sensor was exposed to image light prior to the application of voltage to the electrodes, and the application of voltage and exposure were finished at the same time, as shown in FIG. 32. The results of a comparison of the signals read out of the images recorded in both cases are shown in FIG. 33. In either case, the exposure time was 2 seconds and a voltage of 700 volts was applied to the electrodes for 65 msec. In FIG. 33, ◯ are data obtained by the voltage applying and exposure method shown in FIG. 32, and X are data obtained by the voltage applying and exposure method shown in FIG. 31(b). It is here to be noted that he characteristics of ◯ are identical with those of Δ in FIG. 30. As can be seen from this figure, when the sensor is exposed to light at the same time as the application of voltage to the electrodes, the characteristic curve is largely shifted to the high intensity side, because the light after the finish of the application of voltage becomes entirely useless. It is also seen that by starting the exposure of the sensor to image light prior to the application of voltage to the electrodes, it is possible to avoid any shift of the characteristic curve to the high intensity side even when the sensor is exposed to light for a long period of time. By exposing the sensor to light before the application of voltage to the electrodes is started, it is thus possible to prevent any shift of the characteristic curve to the high intensity side or, in other words, to shift the characteristic curve to the low intensity side, so that the exposure time before the application of voltage to the electrodes is started can be regulated to compensate for the reciprocity low failure.

### Method for Compensating for the Reciprocity Law Failure when Exposure Time is Equal to Voltage Applying Time

In the system of the present invention, the photo-induced current value is not reduced to zero immediately after the exposure of the sensor to light is finished; that is, the photo-induced current continues to flow, albeit decaying slowly. It is thus possible to make efficient use of the photo-induced current by continuing the application of voltage to the electrodes even after the exposure of the sensor to image light is finished. Even when the exposure time is nearly equal to the voltage applying time, the characteristic curve is often shifted to the high intensity side due to a sensitivity drop, if no efficient use is made of the photo-induced current because the sensor remains exposed to light after the application of voltage to the electrodes has been finished. To avoid this, the exposure of the sensor to image light is started before the application of voltage to the electrodes is started, and the application of voltage thereto is continued even after the exposure of the sensor to image light has been finished. By doing so, it is possible to start the application of voltage to the electrodes at such timing that the photo-induced current is increased by exposure to a certain degree, thereby enabling voltage to be applied to the electrodes in a time zone where an increased photo-induced current is obtained and so achieving an improved sensitivity.

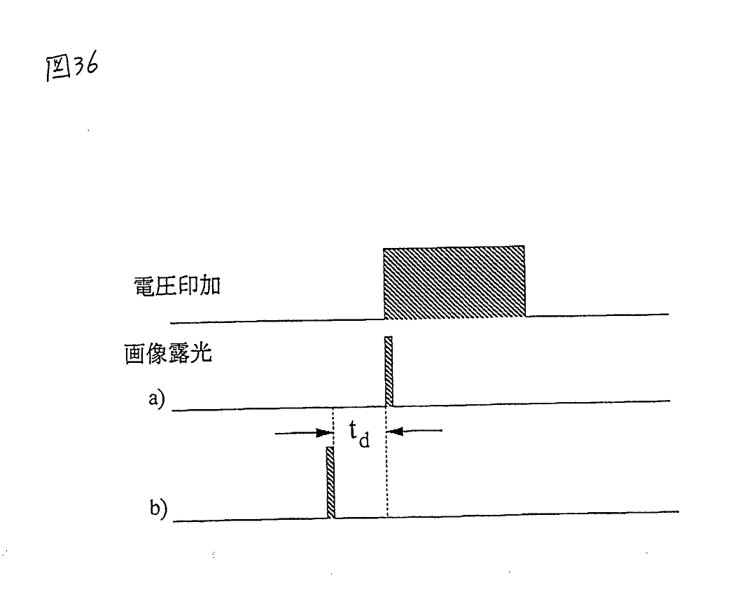

The results of the image recorded by such a method are shown in FIG. 35.

The image was recorded at an applied voltage of 700 volts for an exposure time of 1/15 seconds and a voltage applying time of 65 msec. In an exposure method A, the exposure of the photoelectric sensor to image light was started simultaneously with the application of voltage to the electrodes as illustrated in FIG. 31(a) (shown by X), and in an exposure method B, the application of voltage to the electrodes was started about 30 milliseconds after the start of the exposure of the photoelectric sensor to image light as illustrated in FIG. 34 (shown by 0). As can be seen from FIG. 35, the characteristics curve is shifted to a lower intensity side in the exposure method B than in the exposure method A; in other words, the photo-induced current is more effectively used in B than in A.

Reference will now be made to another method for compensating for the reciprocity law failure.

### Compensation by Shutter Speed and f-Number

In another compensating method of the present invention, a displacement of the characteristic curve is predetermined to regulate shutter speed and f-number, so that an image can be recorded in a proper exposure quantity.

Images were recorded at varying exposure times (shutter speeds) of 1/400 sec., 1/250 sec., 1/125 sec., 1/60 sec., 1/30 sec., 1/15 sec., ⅛ sec., ¼ sec., ½ sec., 1 sec., and 2 sec. When the exposure time was longer than ⅛ seconds, the voltage applying and exposure timings were regulated such that the application of voltage to the electrodes was finished at the same time as the exposure of the photoelectric sensor to image light, as shown in FIG. 32, and the exposure of the sensor to light was then started prior to the application of voltage to the electrodes. The voltage applying time was 65 milliseconds (the period of time in which the voltage of the unexposed portion reached the threshold voltage). When the exposure time was 1/15 sec., an image was recorded by starting the application of voltage to the electrodes 30 milliseconds after the start of the exposure of the sensor to image light so that effective use could be made of the photo-induced current, as explained with reference to FIG. 34.

Mast of the results are as shown in FIG. 30. Within the exposure time range of 1/250 to 1/15 sec., the transmittance change of the liquid crystal medium with respect to exposure quantity has an almost equal value and so the reciprocity law can well apply. As the exposure time increases from 1/15 sec., the characteristic curve has a tendency toward being shifted to the high intensity side even when the sensor is exposed to image light before the application of voltage to the electrodes is started. This is believed to be because as exposure time increases, the photo-induced current is unlikely to change linearly, with a decrease in the quantity of the current increase. However, the quantity of the shift, because of being already compensated for and reduced by exposure before the application of voltage to the electrodes is started, is 0.4 to 0.50 log (lux·sec.) in the case of an exposure time of about 2 seconds.

At a high shutter speed, the characteristic curve shows a tendency toward being shifted to the low intensity side.

From these data, it is found that the system of the present invention fails to satisfy the reciprocity law in a high and low shutter speed region, and such a reciprocity law failure must be compensated for. The reciprocity law, because of applying in a wide range of 1/250 to 1/15 seconds, must be compensated for depending on the respective shutter speeds.

The region that fails to satisfy the reciprocity law, and the quantity of the shift are predetermined by such measurement. By regulating the shutter speed and f-number corresponding to the obtained data, it is possible to record images in a proper exposure quantity.

At a shutter speed of ¼ seconds for instance, the exposure time becomes about 40% longer than at 1/125 seconds, because the then quantity of the shift is 0.2 log (lux·sec.).

In the case of an image recording system (e.g., a camera), it is often impossible to use a well-controlled proper exposure quantity, because any desired value for shutter speed and f-number cannot be selectively used.

An account will now be given of how this can be compensated for.

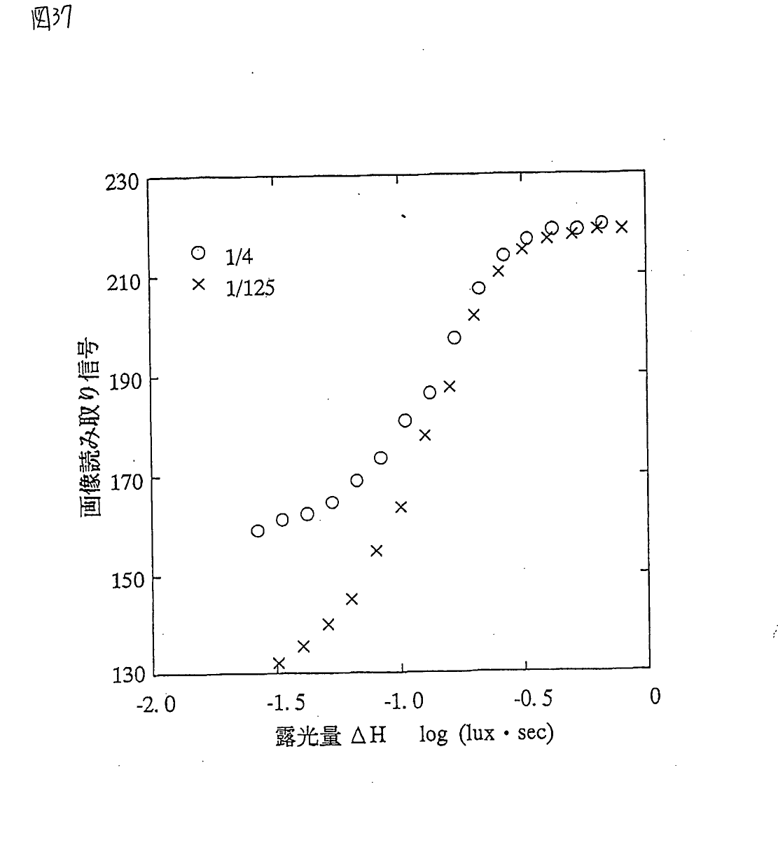

### High Speed Shutter

Where the high speed shutter is used, the characteristic curve is shifted to the low intensity side. By varying the exposure and voltage applying timings as mentioned below, it is thus possible to compensate for the exposure quantity. That is, it is preferable to reduce the exposure quantity. The same effect as achieved by the exposure quantity reduction is obtained by starting the application of voltage to the electrodes at the time when the sensor is exposed to image light before the application of voltage to the electrodes is started (rather than when the sensor is exposed to image light at the same time as the application of voltage to the electrodes), as shown in FIG. 36(b), to allow the photo-induced current to decay. The exposure timing may be regulated by determining the timing t_{d} from the quantity of the shift found from FIG. 30 and the decay curve of the photo-induced current.

By varying the timing t_{d} and thereby changing the apparent sensitivity, it is likewise possible to preset any desired value for f-number under the same exposure conditions. For instance, when it is desired to open the diaphragm, it is preferable to extend the period of time t_{d}.

### Compensation Due to Voltage Applying Conditions

With the method for making compensation for the high speed shutter, it is impossible to make compensation for an extended exposure.

According to the system of the present invention, the characteristic curve can be changed by voltage applying conditions.

As shown in FIG. 30, under the same voltage applying conditions the characteristic curve at a shutter speed of ¼ seconds is shifted to the high intensity side by 0.2 log (lux·sec.) as compared with that at 1/125 seconds.

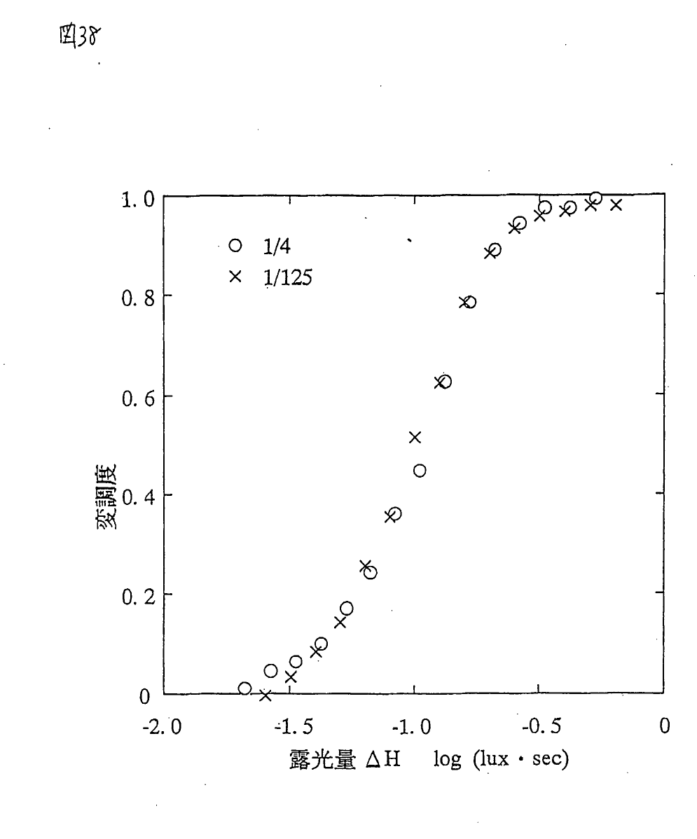

Under the voltage applying conditions of 720 volts and 65 milliseconds, an image was recorded in an exposure time of ¼ seconds. The results are shown in FIG. 37. Due to the applied voltage being high, the transmittance of the liquid crystal medium at the unexposed portion increases. As can be seen from FIG. 38 showing the standardized results of the transmittances of the unexposed portion and the portion exposed to light at high intensity, the characteristic curves coincide with each other. By controlling the voltage applying conditions to place the transmittance of the liquid crystal medium at the unexposed portion under control, it is thus possible to change the characteristic curve. For the high speed shutter, it is possible to shift the characteristic curve to the high intensity side by lowering the applied voltage or shortening the voltage applying time.

### Synchro-Flash Photography

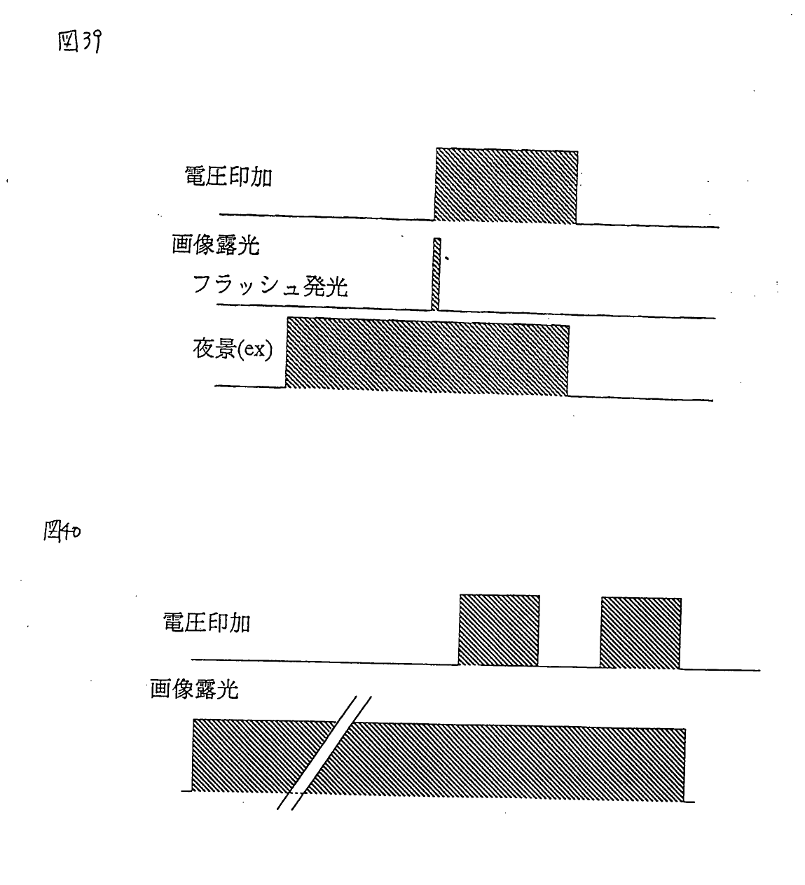

When the system of the present invention is used as mentioned above, the photoelectric sensor is exposed to image light before the application of voltage to the electrodes is started, so that even when the light used is feeble, an image can be recorded on the recording medium if the sensor is exposed thereto for an extended period of time. For instance, this may be applied to taking a photograph of a person with flash, with a night scene for a background. While the photoelectric sensor is being mainly exposed to light from the background, as shown in FIG. 39, it is possible to photograph the person and background at the same time by producing flash concurrently with the application of voltage to the electrodes. In this case, it is desired that the application of voltage be in synchronism with the emission of flash. To say it another way, if the application of voltage to the electrodes is started after the emission of flash, it is then impossible to make effective use of flash. Also, unless the photoelectric sensor is exposed to image light fairly prior to the start of the application of voltage, it is then impossible to record the background with brightness.

It is here to be noted that when the exposure time is long (about 1.5 to 2 seconds), the photo-induced current is saturated and so does not change. For this reason, no effective recording of the image is achieved, even when the exposure and voltage applying times are longer than that. When an image is recorded by exposure long enough to cause the photo-induced current to be saturated, it is preferable to use an image recording method as shown in FIG. 40. That is, the application of voltage to the electrodes is started in a time (40 to 50 milliseconds) during which the photo-induced current is saturated, after the exposure of the photoelectric sensor to image light has been started, followed by the interruption of the application of voltage. After an elapse of a certain time, voltage is again applied to the electrodes in a state where the voltages of the photoelectric sensor and liquid crystal medium have sufficiently decayed, so that the image can be effectively recorded on the liquid crystal medium. In FIG. 40, the application of voltage is shown to be repeated twice. However, it is to be understood that the number of the application of voltage is not critical and so may be two or more although depending on exposure time.

Reference will now be made to one general construction of the information recording system with which the image recording method of the present invention is to be carried out.

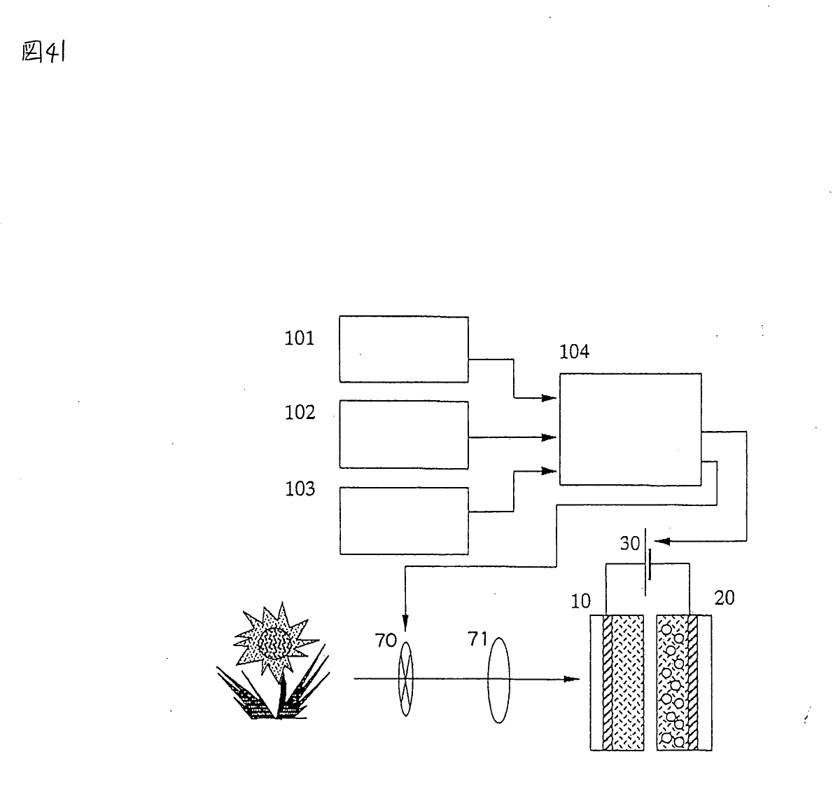

FIG. 41 shows one general construction of the image recording system according to the present invention. In FIG. 41 reference numerals 101 to 103 represent the measuring means needed for recording images according to the present invention. That is, 101 represents photometric means, 102 means for measuring the base current of the photoelectric sensor and/or the resistance and other physical values of the liquid crystal medium, and 103 input means for photographic conditions such as shutter time and/or f-number, etc. If the base current of the sensor and the resistance and other physical values of the liquid crystal medium are known in advance, they may then have been preset by the input means 103. Reference numeral 104 represents a controller made up of a microcomputer, etc., which can compute and determine shutter time on the basis of the intensity of light measured by the photometeric means 101 and the data obtained by the measuring means 102 (or the input physical values of the photoelectric sensor and liquid crystal medium), and can preset the voltage applying conditions (applied voltage and voltage applying time) as well. The controller 104 enables a power source 30 and a shutter 70 to be controlled at timing (or by a method) suitable for the preset shutter time and voltage applying conditions, so that the exposure of the sensor 10 to light and the application of voltage to the electrodes of the sensor 10 and liquid crystal medium 20 can be well controlled for photography under the optimum conditions. Reference numeral 71 stands for a lens.

An account will now be given of a camera to which the recording method wherein the photoelectric sensor is exposed to light before the application of voltage to the electrodes is started is applied, and its working sequence.

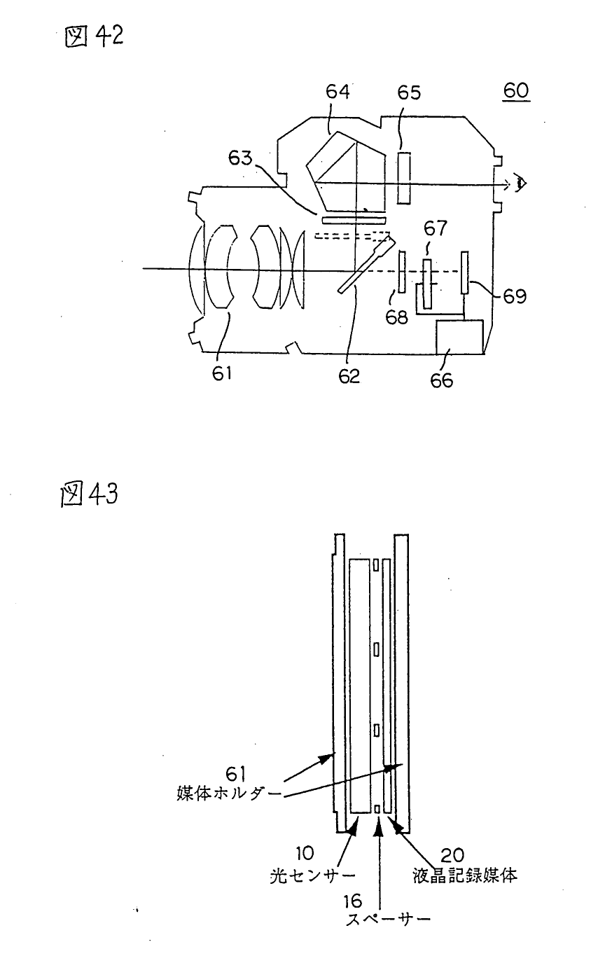

Shown in FIG. 42 is one embodiment of the camera to which the voltage applying and exposure method of the present invention is applied.

In this embodiment, a rotary shutter 67 is built in a single-lens reflex camera 60, and the liquid crystal medium is used in place of conventional film. In association with a power source switch (not shown) that is turned on or off, a mirror 62 is swingable between positions shown by broken and solid lines, respectively. At the position shown by a solid line, the mirror 62 directs light passing through a camera lens system 61 to a penta prism 64, by which the light is directed to an eyepiece 65 which enables the viewer to view the subject and bring it into focus. Upon the power source switch put on for shooting, the mirror 62 is swung up to the position shown by a broken line, so that the light from the subject is directed to a medium holder 69 through the lens system 61, a filter 68 and the rotary shutter 67. The rotary shutter 67 and medium holder 69 are interconnected to a controller 66, so that they can cooperate.

In the medium holder 69, as shown in FIG. 43, a photoelectric sensor 10 is opposed to a liquid crystal recording medium 20 with an air gap of about 9 μm located between them using spacers 16, so that voltage can be applied between the electrodes of the sensor 10 and medium 20 with the electrode of the sensor 10 acting as a positive electrode, and the sensor 10 can be exposed to image light through the substrate. It is here to be noted that the liquid crystal recording medium may be a one-piece type medium wherein a liquid crystal layer and an electrode layer are stacked on the photoelectric sensor in the described order with or without an interlayer located between the liquid crystal layer and the sensor.

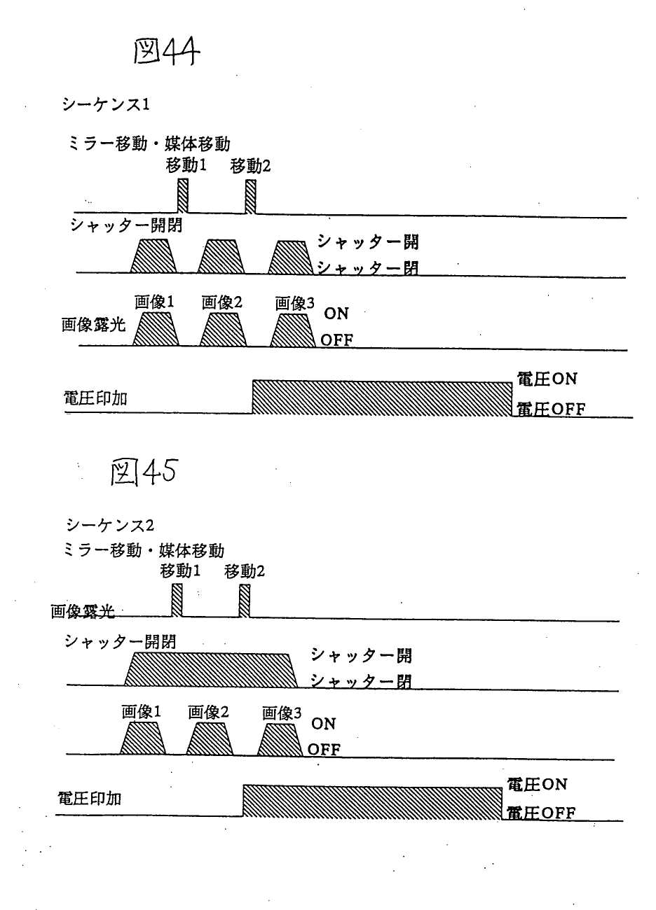

FIG. 44 illustrates one example of the sequence of images. The mirror (a photograph-taking optical system) or the recording medium is moved, during which the shutter is clicked three times to expose the sensor to light for images 1 and 2 before the application of voltage to the electrodes and then expose the sensor to light for image 3 after the application of voltage to the electrodes. In such sequence, images 1-3 can be recorded on the medium at discrete positions.

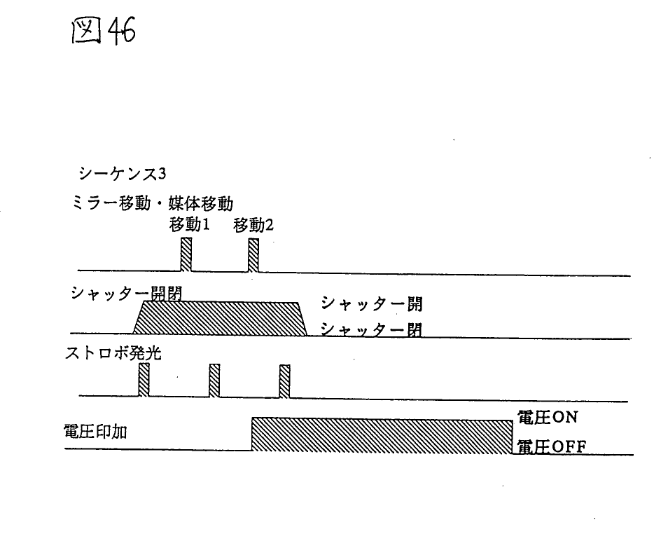

FIG. 45 is similar to FIG. 44 with the exception that the shutter is kept open while the sensor is exposed to light for images 1-3. In this example, too, images 1-3 can be recorded on the medium at discrete positions.

FIG. 46 is an image sequence according to which images are recorded by a strobo flash. In the same sequence as in FIG. 45, images can be recorded by three strobo flashes.

In the present photoelectric sensor designed such that after the sensor is exposed to information light, voltage is applied between its electrode and the electrode of the information recording medium, or while the sensor is being exposed to information light, the application of voltage between its electrode and the electrode of the information recording medium is intermittently interrupted or the application of voltage thereto is once finished and then resumed, there is a large conductivity difference between the exposed and unexposed portions, so that even when the light used is feeble, a liquid crystal recording layer can be used to record information with a striking contrast by exposing the photoelectric sensor thereto for an extended period of time. This is because the voltage of the unexposed portion is unlikely to exceed the threshold voltage of liquid crystals.

According to the present invention, it is possible to expose the photoelectric sensor to image light before the start of application of voltage and thereby change the latitude of the recorded image or make compensation for recording sensitivity, so that the reciprocity law required for cameras can be well satisfied.

1. A photoelectric sensor including a photoconductive layer on an electrode and used to record information on an information recording medium, characterized in that when voltage is applied to said sensor after said sensor has been exposed to light with no voltage applied thereto or voltage of opposite polarity applied thereto, a photo-induced current is generated depending on exposure quantity so that the information can be recorded on said information recording medium

2. A photoelectric sensor including a photo-conductive layer on an electrode and used to record information on an information recording medium, characterized in that said sensor is exposed to information light with voltage applied thereto, whereby the exposed portion is made higher in conductivity than the unexposed portion and the exposed portion is kept still higher in conductivity than the unexposed portion even after the exposure of said sensor to information light has been finished, and while said sensor remains exposed to information light or after the exposure of said sensor to information light has been finished, the application of voltage thereto, and the original voltage is again applied thereto, whereby the resulting conductivity is made equal to that obtained by the continued application of voltage.

3. The photoelectric sensor as claimed in claim 1 or 2, characterized in that when an electric field of 10⁵ or 10⁶ V/m is applied to said sensor, a current passing through the unexposed portion has a current density of 10⁻⁴ to 10⁻⁷ A/cm².

4. An image recording method wherein light information is recorded on an information recording medium by exposure to light information, characterized by the use of a photoelectric sensor as claimed in claim 1 or 3 and an information recording medium having an information recording layer formed on an electrode,
the electrode of at least one of said photoelectric sensor and said information recording medium being a transparent electrode, and
said photoelectric sensor being opposed to said information recording medium on the optical axis with a gap located therebetween, or said photoelectric sensor and said information recording medium being stacked on each other with or without a dielectric interlayer located therebetween,
so that after said sensor has been exposed to light information or while said photoelectric sensor is being exposed to light information, the application of voltage between both said electrodes is started.

5. The information recording method as claimed in claim 4, characterized in that said information recording medium is a liquid crystal recording medium including on said electrode a liquid crystal-polymer composite material layer comprising liquid crystals and resin.

6. The information recording method as claimed in claim 5, characterized in that after an elapse of a certain time upon the exposure of said sensor to light information finished, the application of voltage to both said electrodes is started thereby making the latitude of the recorded image wide.

7. The information recording method as claimed in claim 6, characterized in that the period of time from the finish of the exposure of said sensor to light information to the start of the application of voltage to both said electrodes is 0 to 500 milliseconds.

8. An image recording method wherein light information is recorded on an information recording medium by exposure to information light, characterized by the use of a photoelectric sensor as claimed in claim 2 or 3 an information recording medium including an information recording layer formed on an electrode,
the electrode of at least one of said photoelectric sensor and said information recording medium being a transparent electrode, and
so that sensor is exposed to light information, and while said sensor is being exposed to light information or after said sensor has been exposed to light information, the period of time wherein no voltage is applied to both said electrodes or the period of time wherein voltage of opposite polarity is applied to both said electrodes is provided.

9. The information recording method as claimed in claim 8, characterized in that said information recording medium is a liquid crystal recording medium including on said electrode a liquid crystal-polymer composite material layer comprising liquid crystals and resin.

10. An image recording method wherein light information is recorded on an information recording medium by exposure to light information, wherein the photoelectric sensor and an information recording medium having an information recording layer formed on an electrode are used,
the electrode of at least one of said photoelectric sensor and said information recording medium being a transparent electrode, and
so that said sensor is exposed to light information and voltage is applied between both electrodes of said sensor and said recording medium to record information thereon,
characterized that:
the exposure of said sensor to image light and the application of voltage to both said electrodes are properly achieved in response to shutter speed, so that the reciprocity can be satisfied over a wide range.

11. The information recording method as claimed in claim 10, characterized in that said information recording medium is a liquid crystal recording medium including on said electrode a liquid crystal-polymer composite material layer comprising liquid crystals and resin.

12. The information recording method as claimed in claim 11, characterized in that f-number or exposure time is corrected on the basis of the predetermined relation between the shutter speed and the recording properties, so that the reciprocity law can be satisfied over a wide range.

13. The information recording method as claimed in claim 11, characterized in that a reciprocity law failure is compensated for by starting the exposure of the photoelectric sensor as claimed in claim 1 or 3 to image light prior to starting the application of voltage to both said electrodes.

14. The information recording method as claimed in claim 11, characterized in that the period of time wherein no voltage is applied to both said electrodes or the period of time wherein voltage of opposite polarity is applied to both said electrodes is provided while the photoelectric sensor claimed in claim 2 or 3 is being exposed to image light or after the exposure of said sensor to image light has been finished, thereby compensating for a reciprocity law failure.

15. The information recording method claimed in claim 11, characterized in that the application of voltage to both said electrodes is started after an elapse of a certain time upon the exposure of the photoelectric sensor as claimed in claim 1 or 3 to image light finished.

16. The information recording method as claimed in claim 11, characterized in that the applied voltage and/or the voltage applying time are controlled, thereby compensating for a reciprocity law failure.

17. An information recording method wherein light information is recorded on an information recording medium by exposure to information light, characterized by comprising a photoelectric sensor including an electrode and an information recording medium having an information recording layer formed on an electrode,
the electrode of at least one of said photoelectric sensor and said information recording medium being a transparent electrode, and
said photoelectric sensor being opposed to said information recording medium on the optical axis with a gap located therebetween, or said photoelectric sensor and said information recording medium being stacked on each other with or without a dielectric interlayer located therebetween, and
a mechanism for starting the application of voltage between both said electrodes after said sensor has been exposed to light information or while said sensor is being exposed to light information.

18. An information recording system constructed from a one-piece type medium comprising a photoelectric sensor having a photoelectric layer stacked on a transparent electrode, an information recording medium having an information recording layer stacked on an electrode and an upper electrode, said photoelectric sensor being opposed to said information recording medium on the optical axis with a gap located therebetween, or said photoelectric sensor and said information recording medium being stacked upon each other with or without a dielectric interlayer located therebetween, wherein said photoelectric sensor is exposed to image light and voltage is applied between both said electrodes to record image or other information on said information recording medium in response to exposure quantity, characterized by further including means for measuring exposure intensity to calculate exposure time and/or input means for exposure time, and having a function of controlling a shutter and a power source under proper conditions in response to the exposure time, thereby allowing the reciprocity law to be satisfied over a wide range of exposure time.
